(19) United States
(12) Patent Application Publication
(10) Pub. No.: US 2025/0303364 A1
(43) Pub. Date: Oct. 2, 2025

(54) CATALYST FOR THE SELECTIVE CATALYTIC REDUCTION OF NOX

(71) Applicant: BASF CORPORATION, Florham Park, NJ (US)

(72) Inventors: Claudia ZABEL, Hannover (DE); Sebastian FRIEBE, Nienburg/Weser (DE); Maria LANG, Hannover (DE); Edith SCHNEIDER, Nienburg/Weser (DE)

(21) Appl. No.: 18/291,737

(22) PCT Filed: Jul. 28, 2022
(86) PCT No.: PCT/EP2022/071182

§ 371 Date: Jan. 24, 2024

(30) Foreign Application Priority Data
Jul. 29, 2021 (EP) 21188489.5

(51) Int. Cl. B01D 53/94

(52) U.S. Cl. CPC B01D 53/9418; B01D 2255/50; B01D 2255/9155

(57) ABSTRACT

The present invention relates to a catalyst for the selective catalytic reduction of NOx comprising a wall-flow filter substrate comprising a plurality of passages defined by internal walls of the substrate extending therethrough, wherein the plurality of passages comprises inlet passages having an open inlet end and a closed outlet end, and outlet passages having a closed inlet end and an open outlet end; wherein the porous walls of the substrate comprises a coating, the coating comprising a zeolitic material, copper, a first non-zeolitic oxidic material comprising zirconium, wherein the coating comprises the zeolitic material at loading, L(z), in g/in³, and N the first non-zeolitic oxidic material at a loading L1, in g/in³, the loading ratio L(z) (g/in³):L1 (g/in³) being of at most 10:1; and wherein from 90 to 100 weight-% of the first non-zeolitic oxidic material consists of zirconium, calculated as ZrO₂.

The present invention relates to a catalyst for the selective catalytic reduction of NOx, a process for preparing a catalyst for the selective catalytic reduction of NOx as well as a catalyst obtainable and obtained by said process. Further, the present invention relates to an exhaust gas treatment system comprising said catalyst and a use of said catalyst.

GB2528737B discloses a method for treating exhaust gas, said method comprising the use of a selective catalytic reduction catalyst composition containing a transition metal exchanged small pore zeolite. Further, WO 2020/040944 discloses a selective catalyst reduction catalyst composition comprising a platinum group metal and a zeolitic material promoted with a metal. However, these applications do not deal with the coldflow backpressure or backpressure with soot loading, while it is known that the requirements for selective catalytic reduction catalyst technology are good DeNOx activity over the complete temperature range, good producibility, acceptable coldflow backpressure, good filtration efficiency and a good backpressure behavior with soot loading. Indeed, different factors may have a strong impact on filter behavior with soot.

WO 2020/088531 A1 discloses a process for preparing a catalyst for the selective catalytic reduction of NOx, the catalyst comprising a copper-ion exchanged zeolitic material. However, there is still a need to find a new catalyst for the selective catalytic reduction of NOx which exhibits great NOx conversion and shows reduced backpressure. Further, there is still a need of catalysts which are highly thermally stable.

Therefore, it was an object of the present invention to provide a new catalyst for the selective catalytic reduction of NOx which exhibits great NOx conversion, improved thermal stability and shows reduced backpressure. Surprisingly, it was found that the catalyst of the present invention permits to exhibit great NOx conversion and show reduced backpressure. Further, said catalyst has improved thermal stability compared to the prior art.

Therefore, the present invention relates to a catalyst for the selective catalytic reduction of NOx comprising
a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end;
wherein the porous walls of the substrate comprises a coating, the coating comprising a zeolitic material, copper, a first non-zeolitic oxidic material comprising zirconium, wherein the coating comprises the zeolitic material at loading, L(z), in g/in³, and the first non-zeolitic oxidic material at a loading L1, in g/in³, the loading ratio L(z) (g/in³):L1 (g/in³) being of at most 10:1; and
wherein from 90 to 100 weight-% of the first non-zeolitic oxidic material consists of zirconium, calculated as ZrO₂.

Preferably the zeolitic material comprised in the coating has a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, —CHI, —CLO, CON, CSV, CZP, DAC, DDR, DFO, DFT, DOH, DON, EAB, EDI, EEl, EMT, EON, EPI, ERI, ESV, ETR, EUO, *-EWT, EZT, FAR, FAU, FER, FRA, GIS, GIU, GME, GON, GOO, HEU, IFO, IFR, —IFU, IFW, IFY, IHW, IMF, IRN, IRR, —IRY, ISV, ITE, ITG, ITH, *ITN, ITR, ITT, —ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, —PAR, PAU, PCR, PHI, PON, POS, PSI, PUN, RHO, —RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *—SSO, SSY, STF, STI, *STO, STT, STW, —SVR, SVV, SZR, TER, THO, TOL, TON, TSC, TUN, UEI, UFI, UOS, UOV, UOZ, USI, UTL, UWY, VET, VFI, VNI, VSV, WEI, —WEN, YUG, ZON, a mixture of two or more thereof, and a mixed type of two or more thereof, more preferably selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI. More preferably the zeolitic material comprised in the coating has a framework type CHA.

Preferably from 95 to 100 weight-%, more preferably from 98 to 100 weight-%, more preferably from 99 to 100 weight-% of the framework structure of the zeolitic material consist of Si, Al, and 0.

Preferably, in the framework structure of the zeolitic material comprised in the coating, the molar ratio of Si to Al, calculated as molar SiO₂:Al₂O₃, is in the range of from 2:1 to 30:1, more preferably in the range of from 5:1 to 25:1, more preferably in the range of from 7:1 to 22:1, more preferably in the range of from 8:1 to 20:1, more preferably in the range of from 9:1 to 18:1, more preferably in the range of from 10:1 to 17:1, more preferably in the range of from 12:1 to 16:1.

Preferably the zeolitic material comprised in the coating, more preferably which has a framework type CHA, has a mean crystallite size of at least 0.1 micrometer, more preferably in the range of from 0.1 to 3.0 micrometers, more preferably in the range of from 0.3 to 1.5 micrometer, more preferably in the range of from 0.4 to 1.0 micrometer determined via scanning electron microscopy.

Preferably the amount of copper comprised in the coating, calculated as CuO, is in the range of from 2 to 10 weight-%, more preferably in the range of from 2.5 to 5.5 weight-%, more preferably in the range of from 3 to 5 weight-% based on the weight of the zeolitic material.

Preferably the zeolitic material comprised in the coating comprises copper.

Preferably the coating comprises the zeolitic material at a loading in the range of from 0.5 to 5 g/in³, more preferably in the range of from 0.75 to 3 g/in³, more preferably in the range of from 1 to 2.5 g/in³, more preferably in the range of from 1.25 to 2 g/in³.

Preferably from 95 to 100 weight-%, more preferably from 98 to 100 weight-%, more preferably from 99 to 100 weight-%, more preferably from 99.5 to 100 weight-%, of the first non-zeolitic oxidic material comprised in the coating consists of zirconium, calculated as ZrO₂. The first non-zeolitic oxidic material preferably is zirconia (ZrO₂). In other words, it is preferred that the first non-zeolitic oxidic material comprised in the coating consists substantially of, more preferably consists of, zirconia (ZrO₂).

It is preferred that the coating comprises the zeolitic material at loading, L(z), in g/in³, and the first non-zeolitic oxidic material, more preferably zirconia, at a loading L1, in g/in³, wherein the loading ratio L(z) (g/in³):L1 (g/in³) is in the range of from 10:1 to 1.1:1, more preferably in the range of from 9:1 to 1.25:1, more preferably in the range of from 8:1 to 2:1, more preferably in the range of from 7.5:1 to 2.5:1, more preferably in the range of from 7:1 to 3.5:1, more preferably in the range of from 5.5:1 to 4:1.

Therefore, the present invention preferably relates to a catalyst for the selective catalytic reduction of NOx comprising
a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end;
wherein the porous walls of the substrate comprises a coating, the coating comprising a zeolitic material having a framework type CHA, copper, a first non-zeolitic oxidic material comprising zirconium,
wherein the coating comprises the zeolitic material at loading, L(z), in g/in³, and the first non-zeolitic oxidic material at a loading L1, in g/in³, the loading ratio L(z) (g/in³):L1 (g/in³) being in the range of from 9:1 to 1.25:1, more preferably in the range of from 8:1 to 2:1, more preferably in the range of from 7.5:1 to 2.5:1, more preferably in the range of from 7:1 to 3.5:1, more preferably in the range of from 5.5:1 to 4:1; and
wherein from 90 to 100 weight-%, more preferably from 95 to 100 weight-%, more preferably from 98 to 100 weight-%, more preferably from 99 to 100 weight-%, more preferably from 99.5 to 100 weight-%, of the first non-zeolitic oxidic material consists of zirconium, calculated as ZrO₂.

In the context of the present invention, it is preferred that the coating further comprises a second non-zeolitic oxidic material selected from the group consisting of alumina, silica, titania, ceria, a mixed oxide comprising one or more of Al, Si, Ti, and Ce and a mixture of two or more thereof, more preferably selected from the group consisting of alumina, silica, and titania, a mixed oxide comprising one or more of Al, Si, and Ti and a mixture of two or more thereof, more preferably selected from the group consisting of alumina, silica, a mixed oxide comprising one or more of Al and Si, and a mixture of two or more thereof, more preferably is a mixture of alumina and silica.

Preferably from 80 to 99 weight-%, more preferably from 85 to 98 weight-%, more preferably from 90 to 98 weight-%, of the mixture of alumina and silica consist of alumina, and preferably from 1 to 20 weight-%, preferably from 2 to 15 weight-%, more preferably from 2 to 10 weight-% of the mixture of alumina and silica consist of silica.

Preferably the coating comprises the second non-zeolitic oxidic material in an amount in the range of from 2 to 20 weight-%, more preferably in the range of from 5 to 15 weight-%, more preferably in the range of from 7 to 13 weight-%, based on the weight of the zeolitic material.

Preferably from 0 to 0.001 weight-%, more preferably from 0 to 0.0001 weight-%, more preferably from 0 to 0.00001 weight-%, of the coating consists of platinum group metal. In other words, it is preferred that the coating be substantially free of, more preferably free of, platinum group metal.

Preferably the coating extends over x % of the substrate axial length, from the inlet end toward the outlet end of the substrate or from the outlet end toward the inlet end of the substrate, wherein x is in the range of from 95 to 100, preferably in the range of from 98 to 100, more preferably in the range of from 99 to 100.

Preferably from 90 to 100 weight-%, more preferably from 95 to 100 weight-%, more preferably from 98 to 100 weight-%, of the coating is comprised in the porous walls of the substrate.

It is preferred that the coating of the catalyst of the present invention be present substantially only within the porous walls of the substrate, more preferably only within the porous walls of the substrate. It is further conceivable that in the middle zone of the substrate axial length a minor amount of coating might be present on the surface of the internal walls.

Preferably the coating is disposed homogeneously along the substrate axial length.

It can also be preferred that the amount of coating is higher in the middle zone of the substrate axial length compared to the amount present at each of the inlet end of the substrate and the outlet end of the substrate. This is due to one of the coating methods described in the following, wherein the substrate is preferably first coated over less than the substrate axial length, over about 50 to 90%, more preferably about 60 to 80%, more preferably about 65 to 75%, of the substrate axial length from the inlet end toward the outlet end or from the outlet end toward the inlet end and the substrate is then further coated from the other of the inlet or outlet end over less than the substrate axial length, over about 50 to 90%, more preferably about 60 to 80%, more preferably about 65 to 75%, of the substrate axial length.

In the context of the present invention, it is preferred that the substrate is one or more of a cordierite wall-flow filter substrate, a silicon carbide wall-flow filter substrate and an aluminum titanate wall-flow filter substrate, more preferably one or more of a silicon carbide wall-flow filter substrate and an aluminum titanate wall-flow filter substrate.

Preferably the substrate is a silicon carbide wall-flow filter substrate or an aluminum titanate wall-flow filter substrate.

It is preferred that the catalyst consists of the wall-flow filter substrate and the coating.

The present invention further relates to a process for preparing a catalyst for the selective catalytic reduction of NOx, preferably the catalyst according to the present invention, the process comprising
(i) preparing a first aqueous mixture comprising water, a source of copper and a precursor of a first non-zeolitic oxidic component comprising zirconium;
(ii) preparing a second aqueous mixture comprising water and a zeolitic material, wherein the zeolitic material is free of copper;
(iii) admixing the first aqueous mixture obtained according to (i) and the second aqueous mixture obtained according to (ii), obtaining a third aqueous mixture, wherein in the third aqueous mixture, the amount of the precursor of the first non-zeolitic oxidic component, calculated as an oxide, is of at least 10 weight-% based on the weight of the zeolitic material;
(iv) disposing the third aqueous mixture on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and optionally drying the substrate comprising said mixture;
(v) calcining the substrate obtained in (iv).

Preferably the source of copper comprised in the first aqueous mixture prepared in (i) is selected from the group consisting of copper acetate, copper nitrate, copper sulfate, copper formate, copper oxide, and a mixture of two or more thereof, more preferably selected from the group consisting of copper acetate, copper oxide, and a mixture of thereof, more preferably copper oxide, more preferably CuO.

Preferably the precursor of a first non-zeolitic oxidic component comprised in the first aqueous mixture prepared in (i) is a zirconium salt or a zirconium oxide, more preferably a zirconium salt, more preferably zirconium acetate.

Preferably the first aqueous mixture prepared in (i) comprises copper, calculated as CuO, at an amount in the range of from 2 to 10 weight-%, more preferably in the range of from 2.5 to 5.5 weight-%, more preferably in the range of from 3 to 5 weight-%, based on the weight of the zeolitic material comprised in the second aqueous mixture prepared in (ii).

It is preferred that, in the first aqueous mixture, the amount of the precursor of the first non-zeolitic oxidic material, calculated as an oxide, is in the range of from 10 to 80 weight-%, more preferably in the range of from 11 to 80 weight-%, more preferably in the range of from 12.5 to 50 weight-%, more preferably in the range of from 13 to 40 weight-%, more preferably in the range of from 14.3 to 28.5 weight-%, more preferably in the range of from 18 to 25 weight-%, based on the weight of the zeolitic material comprised in the second aqueous mixture prepared in (ii). It is more preferred that, in the first aqueous mixture, the amount of zirconium acetate, calculated as ZrO₂, is in the range of from 10 to 80 weight-%, more preferably in the range of from 11 to 80 weight-%, more preferably in the range of from 12.5 to 50 weight-%, more preferably in the range of from 13 to 40 weight-%, more preferably in the range of from 14.3 to 28.5 weight-%, more preferably in the range of from 18 to 25 weight-%, based on the weight of the zeolitic material comprised in the second aqueous mixture prepared in (ii).

As to (i), it is preferred that it comprises
(i.1) preparing a mixture comprising water and the source of copper, the mixture more preferably further comprising an acid, more preferably an organic acid, more preferably acetic acid;
(i.2) adding the precursor of the first non-zeolitic oxidic component, more preferably zirconium acetate, to the mixture obtained according to (i.1), obtaining the first aqueous mixture.

Preferably from 90 to 100 weight-%, more preferably from 93 to 99 weight-%, more preferably from 96 to 99 weight-%, of the source of copper is present in the mixture prepared in
(i.1) in non-dissolved state.

Preferably the particles of copper in the mixture according to (i.1) have a Dv90 in the range of from 0.1 to 15 micrometers, more preferably in the range of from 0.5 to 10 micrometers, more preferably in the range of from 1 to 8 micrometers, more preferably in the range of from 3 to 7 micrometers, the Dv90 being more preferably determined as described in Reference Example 3.

Preferably the particles of copper in the mixture according to (i.1) have a Dv50 in the range of from 0.1 to 5 micrometers, more preferably in the range of from 0.5 to 3 micrometers, more preferably in the range of from 0.75 to 2 micrometers, the Dv50 being more preferably determined as described in Reference Example 3.

Preferably the mixture obtained in (i.1) has a solid content in the range of from 4 to 30 weight-%, more preferably in the range of from 4 to 21 weight-%, based on the weight of the mixture obtained in (i.1).

Preferably the second mixture obtained in (ii) has a solid content in the range of from 15 to 50 weight-%, more preferably in the range of from 20 to 45 weight-%, more preferably in the range of from 30 to 40 weight-%, based on the weight of the second mixture.

Preferably the particles of the zeolitic material in the second mixture have a Dv90 in the range of from 1 to 10 micrometers, more preferably in the range of from 2 to 6 micrometers, the Dv90 being more preferably determined as described in Reference Example 3.

In the second mixture obtained in (ii), the zeolitic material preferably is in its H-form.

Preferably the particles of the zeolitic material in the second mixture have a Dv50 in the range of from 0.5 to 5 micrometers, more preferably in the range of from 0.75 to 3 micrometers, the Dv90 being preferably determined as described in Reference Example 3.

As to (iii), it is preferred that it comprises
(iii.1) admixing the first aqueous mixture obtained according to (i) and the second aqueous mixture according to (ii);
(iii.2) more preferably milling the obtained mixture (iii.1), more preferably until the particles of said mixture have a Dv90 in the range of from 0.5 to 8 micrometers, more preferably in the range of from 1 to 5 micrometers, more preferably in the range of from 1.5 to 4 micrometers, the Dv90 being more preferably determined as described in Reference Example 3
(iii.3) preparing a mixture comprising water, a second non-zeolitic oxidic material selected from the group consisting of alumina, silica, titania, ceria, a mixed oxide comprising one or more of Al, Si, Ti, and Ce and a mixture of two or more thereof;
(iii.4) admixing the mixture obtained in (iii.3) with the mixture obtained in (iii.1), more preferably in (iii.2), obtaining the third aqueous mixture.

Preferably the mixture prepared in (iii.3) has a solid content in the range of from 15 to 60 weight-%, more preferably in the range of from 20 to 45 weight-%, more preferably in the range of from 25 to 40 weight-%, based on the weight of said mixture.

Preferably the particles of the second non-zeolitic oxidic material in the mixture prepared in (iii.3) have a Dv90 in the range of from 2 to 12 micrometers, more preferably in the range of from 3 to 7 micrometers, the Dv90 being more preferably determined as described in Reference Example 3.

Preferably the particles of the zeolitic material in the second mixture have a Dv50 in the range of from 0.75 to 6 micrometers, more preferably in the range of from 1.5 to 4 micrometers, the Dv90 being more preferably determined as described in Reference Example 3.

Preferably the second non-zeolitic oxidic material contained in the mixture prepared in (iii.3) is selected from the group consisting of alumina, silica, and titania, a mixed oxide comprising one or more of Al, Si, and Ti and a mixture of two or more thereof, more preferably selected from the group consisting of alumina, silica, a mixed oxide comprising one or more of Al and Si, and a mixture of two or more thereof, more preferably a mixture of alumina and silica.

Preferably from 80 to 99 weight-%, more preferably from 85 to 98 weight-%, more preferably from 90 to 98 weight-%, of the mixture of alumina and silica consist of alumina and more preferably from 1 to 20 weight-%, more preferably from 2 to 15 weight-%, more preferably from 2 to 10 weight-% of the mixture of alumina and silica consist of silica.

Preferably the mixture prepared in (iii.3) comprises the second non-zeolitic oxidic material in an amount in the range of from 2 to 20 weight-%, more preferably in the range of from 5 to 15 weight-%, more preferably in the range of from 7 to 13 weight-%, based on the weight of the zeolitic material.

As to the third aqueous mixture obtained in (iii), preferably in (iii.4), it is preferred that said mixture has a solid content in the range of from 15 to 50 weight-%, more preferably in the range of from 20 to 45 weight-%, more preferably in the range of from 25 to 40 weight-%, based on the weight of the third aqueous mixture.

Preferably from 98 to 100 weight-%, more preferably from 99 to 100 weight-%, more preferably from 99.5 to 100 weight-%, more preferably from 99.9 to 100 weight-%, of the third aqueous mixture prepared in (iii) consist of water, the zeolitic material, the source of copper, the precursor of the first non-zeolitic oxidic material, being more preferably zirconium acetate, and more preferably the second non-zeolitic oxidic material as defined in the foregoing.

Preferably disposing the mixture according to (iv) is performed by spraying the mixture onto the substrate or by immersing the substrate into the mixture, more preferably by immersing the substrate into the mixture.

Preferably the third aqueous mixture obtained according to (iii) is disposed according to (iv) over x % of the substrate axial length from the inlet end to the outlet end of the substrate or from the outlet end to the inlet end of the substrate, wherein x is in the range of from 95 to 100, more preferably in the range of from 98 to 100, more preferably in the range of from 99 to 100.

As to the substrate in (iv), it is noted that any substrate can be used as far as it is a wall-flow filter substrate. However, it is preferred that the substrate in (iv) is one or more of a cordierite wall-flow filter substrate, a silicon carbide wall-flow filter substrate and an aluminum titanate wall-flow filter substrate, more preferably one or more of a silicon carbide wall-flow filter substrate and an aluminum titanate wall-flow filter substrate, more preferably a silicon carbide wall-flow filter substrate or an aluminum titanate wall-flow filter substrate.

As to drying according to (iv), it is preferred that it is performed in a gas atmosphere having a temperature in the range of from 60 to 300° C., more preferably in the range of from 90 to 150° C., the gas atmosphere more preferably comprising oxygen.

As to drying according to (iv), it is preferred that it is performed in a gas atmosphere for a duration in the range of from 10 minutes to 4 hours, more preferably in the range of from 20 minutes to 2 hours, the gas atmosphere more preferably comprising oxygen.

As to disposing according to (iv), it exists an alternative preferred method according to which disposing according to (iv) preferably comprises
(iv.1) disposing a first portion of the third aqueous mixture obtained in (iii) on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and drying the substrate comprising the first portion of the third aqueous mixture;
(iv.2) disposing a second portion of the third aqueous mixture obtained in (iii) on the substrate comprising the first portion of the third aqueous mixture obtained in (iv.1), and optionally drying the substrate comprising the first portion and the second portion of the third aqueous mixture.

Preferably the first portion of the third aqueous mixture according to (iii) is disposed according to (iv.1) over x1% of the substrate axial length from the inlet end to the outlet end of the substrate or from the outlet end to the inlet end of the substrate, wherein x1 is in the range of from 95 to 100, more preferably in the range of from 98 to 100, more preferably in the range of from 99 to 100.

Preferably the second portion of the third aqueous mixture according to (iii) is disposed according to (iv.2) over x2% of the substrate axial length from the inlet end to the outlet end of the substrate or from the outlet end to the inlet end of the substrate, wherein x2 is in the range of from 95 to 100, more preferably in the range of from 98 to 100, more preferably in the range of from 99 to 100. It is more preferred that x1 is in the range of from 95 to 100, more preferably in the range of from 98 to 100, more preferably in the range of from 99 to 100, and that x2=x1.

Alternatively, it is preferred that the first portion of the third aqueous mixture according to (iii) is disposed according to (iv.1) over x1% of the substrate axial length from the inlet end to the outlet end of the substrate or from the outlet end to the inlet end of the substrate, wherein x1 is in the range of from 50 to 90, more preferably in the range of from 60 to 80, more preferably in the range of from 65 to 75.

Preferably the second portion of the third aqueous mixture according to (iii) is disposed according to (iv.2) over x2% of the substrate axial length from the inlet end to the outlet end of the substrate or from the outlet end to the inlet end of the substrate, wherein x2 is in the range of from 50 to 90, more preferably in the range of from 60 to 80, more preferably in the range of from 65 to 75. It is more preferred that x1 is in the range of from 50 to 90, more preferably in the range of from 60 to 80, more preferably in the range of from 65 to 75, and that x2=x1.

It is more preferred that the first portion of the third aqueous mixture according to (iii) is disposed according to (iv.1) over x1% of the substrate axial length from the outlet end to the inlet end of the substrate and that the second portion of the third aqueous mixture according to (iii) is disposed according to (iv.2) over x2% of the substrate axial length from the inlet end to the outlet end of the substrate. The other way around is also conceivable.

Preferably drying according to (iv.1) is performed in a gas atmosphere having a temperature in the range of from 60 to 300° C., more preferably in the range of from 90 to 150° C., the gas atmosphere more preferably comprising oxygen.

Preferably drying according to (iv.1) is performed in a gas atmosphere for a duration in the range of from 10 minutes to 4 hours, more preferably in the range of from 20 minutes to 2 hours, the gas atmosphere more preferably comprising oxygen.

Preferably drying according to (iv.2) is performed in a gas atmosphere having a temperature in the range of from 60 to 300° C., more preferably in the range of from 90 to 150° C., the gas atmosphere more preferably comprising oxygen.

Preferably drying according to (iv.2) is performed in a gas atmosphere for a duration in the range of from 10 minutes to 4 hours, more preferably in the range of from 20 minutes to 2 hours, the gas atmosphere more preferably comprising oxygen.

As to calcining according to (v), it is preferred that it is performed in a gas atmosphere having a temperature in the range of from 300 to 900° C., more preferably in the range of from 400 to 650° C., more preferably in the range of from 400 to 500° C., the gas atmosphere more preferably comprising oxygen.

As to calcining according to (v), it is preferred that it is performed in a gas atmosphere for a duration in the range of from 0.1 to 4 hours, more preferably in the range of from 0.5 to 2.5 hours, the gas atmosphere more preferably comprising oxygen.

In the context of the present invention, it is preferred that the process consists of (i), (ii), (iii), (iv) and (v).

The present invention further relates to a catalyst for the selective catalytic reduction of NOx obtainable or obtained by a process according to the present invention and as defined in the foregoing. The catalyst is preferably the catalyst of the present invention and defined in the foregoing.

The present invention further relates to an exhaust gas treatment system for treating exhaust gas exiting a compression ignition engine, said exhaust gas treatment system having an upstream end for introducing said exhaust gas stream into said exhaust gas treatment system, wherein said exhaust gas treatment system comprises a catalyst according to the present invention and as defined in the foregoing, one or more of a diesel oxidation catalyst, a selective catalytic reduction catalyst, an ammonia oxidation catalyst, a NOx trap and a particulate filter. It is preferred that the compression ignition engine is a diesel engine.

Preferably the system comprises the catalyst according to the present invention, a diesel oxidation catalyst and a selective catalytic reduction catalyst;
wherein the diesel oxidation catalyst more preferably is located upstream of the selective catalytic reduction catalyst and the selective catalytic reduction catalyst is located upstream of the catalyst according to the present invention.

Alternatively, the system preferably comprises the catalyst according to the present invention, a NOx trap and a selective catalytic reduction catalyst;
wherein the NOx trap more preferably is located upstream of the selective catalytic reduction catalyst and the selective catalytic reduction catalyst is located upstream of the catalyst according to the present invention.

Alternatively, the system preferably comprises the catalyst according to the present invention, a diesel oxidation catalyst and a selective catalytic reduction catalyst; wherein more preferably the diesel oxidation catalyst is located upstream of the catalyst according to the present invention and the catalyst according to the present invention is located upstream of the selective catalytic reduction catalyst.

Alternatively, the system preferably comprises the catalyst according to the present invention, a NOx trap and a selective catalytic reduction catalyst;
wherein the NOx trap more preferably is located upstream of the catalyst according to the present invention and the catalyst according to the present invention is located upstream of the selective catalytic reduction catalyst. More preferably the system further comprises an ammonia oxidation catalyst or a selective catalytic reduction/ammonia oxidation catalyst, more preferably located downstream of the selective catalytic reduction catalyst.

The present invention further relates to a use of a catalyst, according to the present invention and as defined in the foregoing, for the selective catalytic reduction of NOx.

The present invention further relates to a method for the selective catalytic reduction of NOx, the method comprising
(1) providing an exhaust gas stream, more preferably exiting a diesel engine;
(2) contacting the exhaust gas stream provided in (1) with a catalyst for the selective catalytic reduction of NOx according to the present invention.

The present invention is further illustrated by the following set of embodiments and combinations of embodiments resulting from the dependencies and back-references as indicated.

In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A catalyst for the selective catalytic reduction of NOx comprising a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end;
   wherein the porous walls of the substrate comprises a coating, the coating comprising a zeolitic material, copper, a first non-zeolitic oxidic material comprising zirconium, wherein the coating comprises the zeolitic material at loading, L(z), in g/in³, and the first non-zeolitic oxidic material at a loading L1, in g/in³, the loading ratio L(z) (g/in³):L1 (g/in³) being of at most 10:1; and
   wherein from 90 to 100 weight-% of the first non-zeolitic oxidic material consists of zirconium, calculated as ZrO₂.
2. The catalyst of embodiment 1, wherein the zeolitic material comprised in the coating has a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, —CHI, —CLO, CON, CSV, CZP, DAC, DDR, DFO, DFT, DOH, DON, EAB, EDI, EEl, EMT, EON, EPI, ERI, ESV, ETR, EUO, *-EWT, EZT, FAR, FAU, FER, FRA, GIS, GIU, GME, GON, GOO, HEU, IFO, IFR, —IFU, IFW, IFY, IHW, IMF, IRN, IRR, —IRY, ISV, ITE, ITG, ITH, *—ITN, ITR, ITT, —ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, —PAR, PAU, PCR, PHI, PON, POS, PSI, PUN, RHO, —RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *—SSO, SSY, STF, STI, *STO, STT, STW, —SVR, SVV, SZR, TER, THO, TOL, TON, TSC, TUN, UEI, UFI, UOS, UOV, UOZ, USI, UTL, UWY, VET, VFI, VNI, VSV, WEI, —WEN, YUG, ZON, a mixture of two or more thereof, and a mixed type of two or more thereof, preferably selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, wherein the zeolitic material comprised in the coating more preferably has a framework type CHA.
3. The catalyst of embodiment 1 or 2, wherein from 95 to 100 weight-%, preferably from 98 to 100 weight-%, more preferably from 99 to 100 weight-% of the framework structure of the zeolitic material consist of Si, Al, and O, wherein in the framework structure, the molar ratio of Si to Al, calculated as molar SiO₂:Al₂O₃, is preferably in the range of from 2:1 to 30:1, more preferably in the range of from 5:1 to 25:1, more preferably in the range of from 7:1 to 22:1, more preferably in the range of from 8:1 to 20:1, more preferably in the range of from 9:1 to 18:1, more preferably in the range of from 10:1 to 17:1, more preferably in the range of from 12:1 to 16:1.
4. The catalyst of any one of embodiments 1 to 3, wherein the zeolitic material comprised in the coating, preferably which has a framework type CHA, has a mean crystallite size of at least 0.1 micrometer, preferably in the range of from 0.1 to 3.0 micrometers, more preferably in the range of from 0.3 to 1.5 micrometer, more preferably in the range of from 0.4 to 1.0 micrometer determined via scanning electron microscopy.
5. The catalyst of any one of embodiments 1 to 4, wherein the amount of copper comprised in the coating, calculated as CuO, is in the range of from 2 to 10 weight-%, preferably in the range of from 2.5 to 5.5 weight-%, more preferably in the range of from 3 to 5 weight-% based on the weight of the zeolitic material.
6. The catalyst of any one of embodiments 1 to 5, wherein the zeolitic material comprised in the coating comprises copper.
7. The catalyst of any one of embodiments 1 to 6, wherein the coating comprises the zeolitic material at a loading in the range of from 0.5 to 5 g/in³, preferably in the range of from 0.75 to 3 g/in³, more preferably in the range of from 1 to 2.5 g/in³, more preferably in the range of from 1.25 to 2 g/in³.
8. The catalyst of any one of embodiments 1 to 7, wherein from 95 to 100 weight-%, preferably from 98 to 100 weight-%, more preferably from 99 to 100 weight-%, more preferably from 99.5 to 100 weight-%, of the first non-zeolitic oxidic material comprised in the coating consists of zirconium, calculated as ZrO₂.
9. The catalyst of any one of embodiments 1 to 8, wherein the coating comprises the zeolitic material at loading, L(z), in g/in³, and the first non-zeolitic oxidic material, preferably zirconia, at a loading L1, in g/in³, wherein the loading ratio L(z) (g/in³):L1 (g/in³) is in the range of from 10:1 to 1.1:1, preferably in the range of from 9:1 to 1.25:1, more preferably in the range of from 8:1 to 2:1, more preferably in the range of from 7.5:1 to 2.5:1, more preferably in the range of from 7:1 to 3.5:1, more preferably in the range of from 5.5:1 to 4:1.
10. The catalyst of any one of embodiments 1 to 9, wherein the coating further comprises a second non-zeolitic oxidic material selected from the group consisting of alumina, silica, titania, ceria, a mixed oxide comprising one or more of Al, Si, Ti, and Ce and a mixture of two or more thereof, preferably selected from the group consisting of alumina, silica, and titania, a mixed oxide comprising one or more of Al, Si, and Ti and a mixture of two or more thereof, more preferably selected from the group consisting of alumina, silica, a mixed oxide comprising one or more of Al and Si, and a mixture of two or more thereof, more preferably is a mixture of alumina and silica.
11. The catalyst of embodiment 10, wherein from 80 to 99 weight-%, preferably from 85 to 98 weight-%, more preferably from 90 to 98 weight-%, of the mixture of alumina and silica consist of alumina, and from 1 to 20 weight-%, preferably from 2 to 15 weight-%, more preferably from 2 to 10 weight-% of the mixture of alumina and silica consist of silica.
12. The catalyst of embodiment 10 or 11, wherein the coating comprises the second non-zeolitic oxidic material in an amount in the range of from 2 to 20 weight-%, preferably in the range of from 5 to 15 weight-%, more preferably in the range of from 7 to 13 weight-%, based on the weight of the zeolitic material.
13. The catalyst of any one of embodiments 1 to 12, wherein from 0 to 0.001 weight-%, preferably from 0 to 0.0001 weight-%, more preferably from 0 to 0.00001 weight-%, of the coating consists of platinum group metal.
14. The catalyst of any one of embodiments 1 to 13, wherein the coating extends over x % of the substrate axial length, from the inlet end toward the outlet end of the substrate or from the outlet end toward the inlet end of the substrate, wherein x is in the range of from 95 to 100, preferably in the range of from 98 to 100, more preferably in the range of from 99 to 100.
15. The catalyst of any one of embodiments 1 to 14, wherein from 90 to 100 weight-%, preferably from 95 to 100 weight-%, more preferably from 98 to 100 weight-%, of the coating is comprised in the porous walls of the substrate.
16. The catalyst of any one of embodiments 1 to 15, wherein the coating is disposed homogeneously along the substrate axial length or wherein the amount of coating is higher in the middle zone of the substrate axial length compared to the amount present at each of the inlet end of the substrate and the outlet end of the substrate.
17. The catalyst of any one of embodiments 1 to 16, wherein the substrate is one or more of a cordierite wall-flow filter substrate, a silicon carbide wall-flow filter substrate and an aluminum titanate wall-flow filter substrate, preferably one or more of a silicon carbide wall-flow filter substrate and an aluminum titanate wall-flow filter substrate.
18. The catalyst of embodiment 17, wherein the substrate is a silicon carbide wall-flow filter substrate or an aluminum titanate wall-flow filter substrate.
19. The catalyst of any one of embodiments 1 to 18, wherein the catalyst consists of the wall-flow filter substrate and the coating.
20. A process for preparing a catalyst for the selective catalytic reduction of NOx, preferably the catalyst according to any one of embodiments 1 to 19, the process comprising
   (i) preparing a first aqueous mixture comprising water, a source of copper and a precursor of a first non-zeolitic oxidic component comprising zirconium;
   (ii) preparing a second aqueous mixture comprising water and a zeolitic material, wherein the zeolitic material is free of copper;
   (iii) admixing the first aqueous mixture obtained according to (i) and the second aqueous mixture obtained according to (ii), obtaining a third aqueous mixture, wherein in the third aqueous mixture, the amount of the precursor of the first non-zeolitic oxidic component, calculated as an oxide, is of at least 10 weight-% based on the weight of the zeolitic material;
   (iv) disposing the third aqueous mixture on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and optionally drying the substrate comprising said mixture;
   (v) calcining the substrate obtained in (iv).
21. The process of embodiment 20, wherein the source of copper comprised in the first aqueous mixture prepared in (i) is selected from the group consisting of copper acetate, copper nitrate, copper sulfate, copper formate, copper oxide, and a mixture of two or more thereof, preferably selected from the group consisting of copper acetate, copper oxide, and a mixture of thereof, more preferably copper oxide, more preferably CuO.
22. The process of embodiment 20 or 21, wherein the precursor of a first non-zeolitic oxidic component comprised in the first aqueous mixture prepared in (i) is a zirconium salt or a zirconium oxide, preferably a zirconium salt, more preferably zirconium acetate.
23. The process of any one of embodiments 20 to 22, wherein the first aqueous mixture prepared in (i) comprises copper, calculated as CuO, at an amount in the range of from 2 to 10 weight-%, preferably in the range of from 2.5 to 5.5 weight-%, more preferably in the range of from 3 to 5 weight-%, based on the weight of the zeolitic material comprised in the second aqueous mixture prepared in (ii).
24. The process of any one of embodiments 20 to 23, wherein in the first aqueous mixture the amount of the precursor of the first non-zeolitic oxidic material, calculated as an oxide, is in the range of from 10 to 80 weight-%, preferably in the range of from 11 to 80 weight-%, more preferably in the range of from 12.5 to 50 weight-%, more preferably in the range of from 13 to 40 weight-%, more preferably in the range of from 14.3 to 28.5 weight-%, more preferably in the range of from 18 to 25 weight-%, based on the weight of the zeolitic material comprised in the second aqueous mixture prepared in (ii).
25. The process of any one of embodiments 20 to 24, wherein (i) comprises
   (i.1) preparing a mixture comprising water and the source of copper, the mixture preferably further comprising an acid, more preferably an organic acid, more preferably acetic acid;
   (i.2) adding the precursor of the first non-zeolitic oxidic component to the mixture obtained according to (i.1), obtaining the first aqueous mixture.
26. The process of embodiment 25, wherein from 90 to 100 weight-%, preferably from 93 to 99 weight-%, more preferably from 96 to 99 weight-%, of the source of copper is present in the mixture prepared in (i.1) in non-dissolved state.
27. The process of embodiment 26, wherein the particles of copper in the mixture according to (i.1) have a Dv90 in the range of from 0.1 to 15 micrometers, more preferably in the range of from 0.5 to 10 micrometers, more preferably in the range of from 1 to 8 micrometers, more preferably in the range of from 3 to 7 micrometers, the Dv90 being preferably determined as described in Reference Example 3.
28. The process of any one of embodiments 25 to 27, wherein the mixture obtained in (i.1) has a solid content in the range of from 4 to 30 weight-%, preferably in the range of from 4 to 21 weight-%, based on the weight of the mixture obtained in (i.1).
29. The process of any one of embodiments 20 to 28, wherein the second mixture obtained in (ii) has a solid content in the range of from 15 to 50 weight-%, preferably in the range of from 20 to 45 weight-%, more preferably in the range of from 30 to 40 weight-%, based on the weight of the second mixture.
30. The process of any one of embodiments 20 to 29, wherein the particles of the zeolitic material in the second mixture have a Dv90 in the range of from 1 to 10 micrometers, preferably in the range of from 2 to 6 micrometers, the Dv90 being preferably determined as described in Reference Example 3.
31. The process of any one of embodiments 20 to 30, wherein the particles of the zeolitic material in the second mixture have a Dv50 in the range of from 0.5 to 5 micrometers, preferably in the range of from 0.75 to 3 micrometers, the Dv90 being preferably determined as described in Reference Example 3.
32. The process of any one of embodiments 20 to 31, wherein (iii) comprises
   (iii.1) admixing the first aqueous mixture obtained according to (i) and the second aqueous mixture according to (ii);
   (iii.2) preferably milling the obtained mixture (iii.1), more preferably until the particles of said mixture have a Dv90 in the range of from 0.5 to 8 micrometers, more preferably in the range of from 1 to 5 micrometers, more preferably in the range of from 1.5 to 4 micrometers, the Dv90 being preferably determined as described in Reference Example 3;
   (iii.3) preparing a mixture comprising water, a second non-zeolitic oxidic material selected from the group consisting of alumina, silica, titania, ceria, a mixed oxide comprising one or more of Al, Si, Ti, and Ce and a mixture of two or more thereof;
   (iii.4) admixing the mixture obtained in (iii.3) with the mixture obtained in (iii.1), preferably in (iii.2), obtaining the third aqueous mixture.
33. The process of embodiment 32, wherein the mixture prepared in (iii.3) has a solid content in the range of from 15 to 60 weight-%, preferably in the range of from 20 to 45 weight-%, more preferably in the range of from 25 to 40 weight-%, based on the weight of said mixture.
34. The process of embodiment 32 or 33, wherein the particles of the second non-zeolitic oxidic material in the mixture prepared in (iii.3) have a Dv90 in the range of from 2 to 12 micrometers, preferably in the range of from 3 to 7 micrometers, the Dv90 being preferably determined as described in Reference Example 3.
35. The process of any one of embodiments 32 to 34, wherein the particles of the second non-zeolitic oxidic material in the second mixture have a Dv50 in the range of from 0.75 to 6 micrometers, preferably in the range of from 1.5 to 4 micrometers, the Dv90 being preferably determined as described in Reference Example 3.
36. The process of any one of embodiments 32 to 35, wherein the second non-zeolitic oxidic material contained in the mixture prepared in (iii.3) is selected from the group consisting of alumina, silica, and titania, a mixed oxide comprising one or more of Al, Si, and Ti and a mixture of two or more thereof, preferably selected from the group consisting of alumina, silica, a mixed oxide comprising one or more of Al and Si, and a mixture of two or more thereof, more preferably a mixture of alumina and silica; wherein more preferably from 80 to 99 weight-%, more preferably from 85 to 98 weight-%, more preferably from 90 to 98 weight-%, of the mixture of alumina and silica consist of alumina and more preferably from 1 to 20 weight-%, more preferably from 2 to 15 weight-%, more preferably from 2 to 10 weight-% of the mixture of alumina and silica consist of silica.
37. The process of any one of embodiments 32 to 36, wherein the mixture prepared in (iii.3) comprises the second non-zeolitic oxidic material in an amount in the range of from 2 to 20 weight-%, preferably in the range of from 5 to 15 weight-%, more preferably in the range of from 7 to 13 weight-%, based on the weight of the zeolitic material.
38. The process of any one of embodiments 32 to 37, wherein the third aqueous mixture obtained in (iii), preferably in (iii.4), has a solid content in the range of from 15 to 50 weight-%, preferably in the range of from 20 to 45 weight-%, more preferably in the range of from 25 to 40 weight-%, based on the weight of the third aqueous mixture.
39. The process of any one of embodiments 20 to 38, wherein from 98 to 100 weight-%, preferably from 99 to 100 weight-%, more preferably from 99.5 to 100 weight-%, more preferably from 99.9 to 100 weight-%, of the third aqueous mixture prepared in (iii) consist of water, the zeolitic material, the source of copper, the precursor of the first non-zeolitic oxidic material, and preferably the second non-zeolitic oxidic material as defined in any one of embodiments 32 and 34 to 37.
40. The process of any one of embodiments 20 to 39, wherein disposing the mixture according to (iv) is performed by spraying the mixture onto the substrate or by immersing the substrate into the mixture, preferably by immersing the substrate into the mixture.
41. The process of any one of embodiments 20 to 40, wherein the third aqueous mixture obtained according to (iii) is disposed according to (iv) over x % of the substrate axial length from the inlet end to the outlet end of the substrate or from the outlet end to the inlet end of the substrate, wherein x is in the range of from 95 to 100, preferably in the range of from 98 to 100, more preferably in the range of from 99 to 100.
42. The process of any one of embodiments 20 to 41, wherein the substrate in (iv) is one or more of a cordierite wall-flow filter substrate, a silicon carbide wall-flow filter substrate and an aluminum titanate wall-flow filter substrate, preferably one or more of a silicon carbide wall-flow filter substrate and an aluminum titanate wall-flow filter substrate, more preferably a silicon carbide wall-flow filter substrate or an aluminum titanate wall-flow filter substrate.
43. The process of any one of embodiments 20 to 42, wherein drying according to (iv) is performed in a gas atmosphere having a temperature in the range of from 60 to 300° C., preferably in the range of from 90 to 150° C., the gas atmosphere preferably comprising oxygen.
44. The process of any one of embodiments 20 to 43, wherein drying according to (iv) is performed in a gas atmosphere for a duration in the range of from 10 minutes to 4 hours, preferably in the range of from 20 minutes to 2 hours, the gas atmosphere preferably comprising oxygen.
45. The process of any one of embodiments 20 to 44, wherein disposing according to (iv) comprises
   (iv.1) disposing a first portion of the third aqueous mixture obtained in (iii) on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and drying the substrate comprising the first portion of the third aqueous mixture;
   (iv.2) disposing a second portion of the third aqueous mixture obtained in (iii) on the substrate comprising the first portion of the third aqueous mixture obtained in (iv.1), and optionally drying the substrate comprising the first portion and the second portion of the third aqueous mixture.
46. The process of embodiment 45, wherein the first portion of the third aqueous mixture according to (iii) is disposed according to (iv.1) over x1% of the substrate axial length from the inlet end to the outlet end of the substrate or from the outlet end to the inlet end of the substrate, wherein x1 is in the range of from 95 to 100, preferably in the range of from 98 to 100, more preferably in the range of from 99 to 100.
47. The process of embodiment 45 or 46, wherein the second portion of the third aqueous mixture according to (iii) is disposed according to (iv.2) over x2% of the substrate axial length from the inlet end to the outlet end of the substrate or from the outlet end to the inlet end of the substrate, wherein x2 is in the range of from 95 to 100, preferably in the range of from 98 to 100, more preferably in the range of from 99 to 100, more preferably, as far as embodiment 46 depends on embodiment 45, x2=x1.
48. The process of embodiment 45, wherein the first portion of the third aqueous mixture according to (iii) is disposed according to (iv.1) over x1% of the substrate axial length from the inlet end to the outlet end of the substrate or from the outlet end to the inlet end of the substrate, wherein x1 is in the range of from 50 to 90, preferably in the range of from 60 to 80, more preferably in the range of from 65 to 75.
49. The process of embodiment 45 or 48, wherein the second portion of the third aqueous mixture according to (iii) is disposed according to (iv.2) over x2% of the substrate axial length from the inlet end to the outlet end of the substrate or from the outlet end to the inlet end of the substrate, wherein x2 is in the range of from 50 to 90, preferably in the range of from 60 to 80, more preferably in the range of from 65 to 75, more preferably, as far as embodiment 48 depends on embodiment 45, x2=x1.
50. The process of any one of embodiments 45 to 49, wherein drying according to (iv.1) is performed in a gas atmosphere having a temperature in the range of from 60 to 300° C., preferably in the range of from 90 to 150° C., the gas atmosphere preferably comprising oxygen.
51. The process of any one of embodiments 45 to 50, wherein drying according to (iv.1) is performed in a gas atmosphere for a duration in the range of from 10 minutes to 4 hours, preferably in the range of from 20 minutes to 2 hours, the gas atmosphere preferably comprising oxygen.
52. The process of any one of embodiments 45 to 51, wherein drying according to (iv.2) is performed in a gas atmosphere having a temperature in the range of from 60 to 300° C., preferably in the range of from 90 to 150° C., the gas atmosphere preferably comprising oxygen.
53. The process of any one of embodiments 45 to 52, wherein drying according to (iv.2) is performed in a gas atmosphere for a duration in the range of from 10 minutes to 4 hours, preferably in the range of from 20 minutes to 2 hours, the gas atmosphere preferably comprising oxygen.
54. The process of any one of embodiments 20 to 53, wherein calcining according to (v) is performed in a gas atmosphere having a temperature in the range of from 300 to 900° C., preferably in the range of from 400 to 650° C., more preferably in the range of from 400 to 500° C., the gas atmosphere preferably comprising oxygen.
55. The process of any one of embodiments 20 to 54, wherein calcining according to (v) is performed in a gas atmosphere for a duration in the range of from 0.1 to 4 hours, preferably in the range of from 0.5 to 2.5 hours, the gas atmosphere preferably comprising oxygen.
56. The process of any one of embodiments 19 to 54 consisting of (i), (ii), (iii), (iv) and (v).
57. A process for preparing a catalyst for the selective catalytic reduction of NOx, preferably the catalyst according to any one of embodiments 1 to 19, the process comprising
   (i′) preparing a first aqueous mixture comprising water, a source of copper and a precursor of a first non-zeolitic oxidic component comprising zirconium;
   (ii′) admixing a zeolitic material, wherein the zeolitic material is free of copper, with the first mixture obtained according to (i′), obtaining a second aqueous mixture, wherein in the second aqueous mixture, the amount of the precursor of the first non-zeolitic oxidic component, calculated as an oxide, is of at least 10 weight-% based on the weight of the zeolitic material;
   (iii′) disposing the second aqueous mixture on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and optionally drying the substrate comprising said mixture;
   (iv′) calcining the substrate obtained in (iii′).
58. The process of embodiment 57, wherein the source of copper comprised in the first aqueous mixture prepared in (i) is selected from the group consisting of copper acetate, copper nitrate, copper sulfate, copper formate, copper oxide, and a mixture of two or more thereof, preferably selected from the group consisting of copper acetate, copper oxide, and a mixture of thereof, more preferably copper oxide, more preferably CuO.
59. The process of embodiment 57 or 58, wherein the precursor of a first non-zeolitic oxidic component comprised in the first aqueous mixture prepared in (i) is a zirconium salt or a zirconium oxide, preferably a zirconium salt, more preferably zirconium acetate.
60. The process of any one of embodiments 57 to 59, wherein the first aqueous mixture prepared in (i) comprises copper, calculated as CuO, at an amount in the range of from 2 to 10 weight-%, preferably in the range of from 2.5 to 5.5 weight-%, more preferably in the range of from 3 to 5 weight-%, based on the weight of the zeolitic material of the second aqueous mixture obtained according to (ii′).
61. The process of any one of embodiments 57 to 60, wherein in the first aqueous mixture, the amount of the precursor of the first non-zeolitic oxidic material, calculated as an oxide, is in the range of from 10 to 80 weight-%, preferably in the range of from 11 to 80 weight-%, more preferably in the range of from 12.5 to 50 weight-%, more preferably in the range of from 13 to 40 weight-%, more preferably in the range of from 14.3 to 28.5 weight-%, more preferably in the range of from 18 to 25 weight-%, based on the weight of the zeolitic material of the second aqueous mixture obtained according to (ii′).
62. The process of any one of embodiments 57 to 61, wherein (i) comprises
   (i.1) preparing a mixture comprising water and the source of copper, the mixture preferably further comprising an acid, more preferably an organic acid, more preferably acetic acid, wherein more preferably the mixture comprises sucrose, wherein more preferably the weight ratio of copper, calculated as CuO, relative to sucrose is in the range of from 2:1 to 1:2, more preferably in the range of from 1.5:1 to 1:1.5, more preferably in the range of from 1.2:1 to 1:1.2;
   (i.2) adding the precursor of the first non-zeolitic oxidic component to the mixture obtained according to (i′.1), obtaining the first aqueous mixture.
63. The process of embodiment 62, wherein from 90 to 100 weight-%, preferably from 93 to 99 weight-%, more preferably from 96 to 99 weight-%, of the source of copper is present in the mixture prepared in (i′.1) in non-dissolved state.
64. The process of embodiment 63, wherein the particles of copper in the mixture according to (i′.1) have a Dv90 in the range of from 0.1 to 15 micrometers, more preferably in the range of from 0.5 to 10 micrometers, more preferably in the range of from 1 to 8 micrometers, more preferably in the range of from 3 to 7 micrometers, the Dv90 being preferably determined as described in Reference Example 3.
65. The process of any one of embodiments 62 to 64, wherein the mixture obtained in (i′.1) has a solid content in the range of from 4 to 30 weight-%, preferably in the range of from 4 to 21 weight-%, based on the weight of the mixture obtained in (i′.1).
66. The process of any one of embodiments 57 to 65, wherein the second aqueous mixture obtained in (ii′) has a solid content in the range of from 15 to 50 weight-%, preferably in the range of from 20 to 45 weight-%, more preferably in the range of from 30 to 40 weight-%, based on the weight of the second mixture.
67. The process of any one of embodiments 57 to 66, wherein the particles of the zeolitic material in the second aqueous mixture have a Dv90 in the range of from 1 to 10 micrometers, preferably in the range of from 2 to 6 micrometers, the Dv90 being preferably determined as described in Reference Example 3.
68. The process of any one of embodiments 57 to 67, wherein the particles of the zeolitic material in the second aqueous mixture have a Dv50 in the range of from 0.5 to 5 micrometers, preferably in the range of from 0.75 to 3 micrometers, the Dv90 being preferably determined as described in Reference Example 3.
69. The process of any one of embodiments 57 to 68, wherein (ii′) comprises
   (ii′.1) admixing a zeolitic material, wherein the zeolitic material is preferably free of Cu, with the first aqueous mixture obtained according to (i′);
   (ii′.2) preferably milling the obtained mixture (ii′.1), more preferably until the particles of said mixture have a Dv90 in the range of from 0.5 to 8 micrometers, more preferably in the range of from 1 to 5 micrometers, more preferably in the range of from 1.5 to 4 micrometers, the Dv90 being preferably determined as described in Reference Example 3;
   (ii′.3) admixing the second mixture obtained in (ii′.1), preferably in (ii′.2), with a second non-zeolitic oxidic material selected from the group consisting of alumina, silica, titania, ceria, a mixed oxide comprising one or more of Al, Si, Ti, and Ce and a mixture of two or more thereof, obtaining the second aqueous mixture.
70. The process of embodiment 69, wherein the mixture prepared in (ii′.3) has a solid content in the range of from 15 to 60 weight-%, preferably in the range of from 20 to 45 weight-%, more preferably in the range of from 25 to 40 weight-%, based on the weight of said mixture.
71. The process of embodiment 69 or 70, wherein the particles of the second non-zeolitic oxidic material in the mixture prepared in (ii′.3) have a Dv90 in the range of from 2 to 12 micrometers, preferably in the range of from 3 to 7 micrometers, the Dv90 being preferably determined as described in Reference Example 3.
72. The process of any one of embodiments 69 to 71, wherein the particles of the second non-zeolitic oxidic material in the mixture prepared in (ii′.3) have a Dv50 in the range of from 0.75 to 6 micrometers, preferably in the range of from 1.5 to 4 micrometers, the Dv90 being preferably determined as described in Reference Example 3.
73. The process of any one of embodiments 69 to 72, wherein the second non-zeolitic oxidic material contained in the mixture prepared in (ii′.3) is selected from the group consisting of alumina, silica, and titania, a mixed oxide comprising one or more of Al, Si, and Ti and a mixture of two or more thereof, preferably selected from the group consisting of alumina, silica, a mixed oxide comprising one or more of Al and Si, and a mixture of two or more thereof, more preferably a mixture of alumina and silica; wherein more preferably from 80 to 99 weight-%, more preferably from 85 to 98 weight-%, more preferably from 90 to 98 weight-%, of the mixture of alumina and silica consist of alumina and more preferably from 1 to 20 weight-%, more preferably from 2 to 15 weight-%, more preferably from 2 to 10 weight-% of the mixture of alumina and silica consist of silica.
74. The process of any one of embodiments 69 to 73, wherein the mixture prepared in (ii′.2) comprises the second non-zeolitic oxidic material in an amount in the range of from 2 to 20 weight-%, preferably in the range of from 5 to 15 weight-%, more preferably in the range of from 7 to 13 weight-%, based on the weight of the zeolitic material.
75. The process of any one of embodiments 57 to 74, wherein from 98 to 100 weight-%, preferably from 99 to 100 weight-%, more preferably from 99.5 to 100 weight-%, more preferably from 99.9 to 100 weight-%, of the second aqueous mixture prepared in (ii′) consist of water, the zeolitic material, the source of copper, the precursor of the first non-zeolitic oxidic material, and preferably the second non-zeolitic oxidic material as defined in any one of embodiments 69 and 71 to 74.
76. The process of any one of embodiments 57 to 77, wherein disposing the mixture according to (iii′) is performed by spraying the mixture onto the substrate or by immersing the substrate into the mixture, preferably by immersing the substrate into the mixture.
77. The process of any one of embodiments 57 to 76, wherein the second aqueous mixture obtained according to (ii′) is disposed according to (iii′) over x % of the substrate axial length from the inlet end to the outlet end of the substrate or from the outlet end to the inlet end of the substrate, wherein x is in the range of from 95 to 100, preferably in the range of from 98 to 100, more preferably in the range of from 99 to 100.
78. The process of any one of embodiments 57 to 77, wherein the substrate in (iii′) is one or more of a cordierite wall-flow filter substrate, a silicon carbide wall-flow filter substrate and an aluminum titanate wall-flow filter substrate, preferably one or more of a silicon carbide wall-flow filter substrate and an aluminum titanate wall-flow filter substrate, more preferably a silicon carbide wall-flow filter substrate or an aluminum titanate wall-flow filter substrate.
79. The process of any one of embodiments 57 to 78, wherein drying according to (iii′) is performed in a gas atmosphere having a temperature in the range of from 60 to 300° C., preferably in the range of from 90 to 150° C., the gas atmosphere preferably comprising oxygen.
80. The process of any one of embodiments 57 to 79, wherein drying according to (iii′) is performed in a gas atmosphere for a duration in the range of from 10 minutes to 4 hours, preferably in the range of from 20 minutes to 2 hours, the gas atmosphere preferably comprising oxygen.
81. The process of any one of embodiments 57 to 80, wherein disposing according to (iii′) comprises
   (iii′.1) disposing a first portion of the second aqueous mixture obtained in (ii′) on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and drying the substrate comprising the first portion of the second aqueous mixture;
   (iii′.2) disposing a second portion of the second aqueous mixture obtained in (ii′) on the substrate comprising the first portion of the third aqueous mixture obtained in (iii′.1), and optionally drying the substrate comprising the first portion and the second portion of the second aqueous mixture.
82. The process of embodiment 81, wherein the first portion of the second aqueous mixture according to (ii′) is disposed according to (iii′.1) over x1% of the substrate axial length from the inlet end to the outlet end of the substrate or from the outlet end to the inlet end of the substrate, wherein x1 is in the range of from 95 to 100, preferably in the range of from 98 to 100, more preferably in the range of from 99 to 100.
83. The process of embodiment 81 or 82, wherein the second portion of the second aqueous mixture according to (ii′) is disposed according to (iii′.2) over x2% of the substrate axial length from the inlet end to the outlet end of the substrate or from the outlet end to the inlet end of the substrate, wherein x2 is in the range of from 95 to 100, preferably in the range of from 98 to 100, more preferably in the range of from 99 to 100, more preferably x2=x1.
84. The process of embodiment 81, wherein the first portion of the second aqueous mixture according to (ii′) is disposed according to (iii′.1) over x1% of the substrate axial length from the inlet end to the outlet end of the substrate or from the outlet end to the inlet end of the substrate, wherein x1 is in the range of from 50 to 90, preferably in the range of from 60 to 80, more preferably in the range of from 65 to 75.
85. The process of embodiment 81 or 84, wherein the second portion of the second aqueous mixture according to (ii′) is disposed according to (iii′.2) over x2% of the substrate axial length from the inlet end to the outlet end of the substrate or from the outlet end to the inlet end of the substrate, wherein x2 is in the range of from 50 to 90, preferably in the range of from 60 to 80, more preferably in the range of from 65 to 75, more preferably x2=x1.
86. The process of any one of embodiments 81 to 85, wherein drying according to (iii′.1) is performed in a gas atmosphere having a temperature in the range of from 60 to 300° C., preferably in the range of from 90 to 150° C., the gas atmosphere preferably comprising oxygen;
   wherein preferably drying according to (iii′.1) is performed in a gas atmosphere for a duration in the range of from 10 minutes to 4 hours, more preferably in the range of from 20 minutes to 2 hours.
87. The process of any one of embodiments 81 to 86, wherein drying according to (iii′.2) is performed in a gas atmosphere having a temperature in the range of from 60 to 300° C., preferably in the range of from 90 to 150° C., the gas atmosphere preferably comprising oxygen;
   wherein preferably drying according to (iii′.2) is performed in a gas atmosphere for a duration in the range of from 10 minutes to 4 hours, more preferably in the range of from 20 minutes to 2 hours.
88. The process of any one of embodiments 57 to 87, wherein calcining according to (iv′) is performed in a gas atmosphere having a temperature in the range of from 300 to 900° C., preferably in the range of from 400 to 650° C., more preferably in the range of from 400 to 500° C., the gas atmosphere preferably comprising oxygen;
   wherein preferably calcining according to (iv′) is performed in a gas atmosphere for a duration in the range of from 0.1 to 4 hours, more preferably in the range of from 0.5 to 2.5 hours.
89. The process of any one of embodiments 57 to 88 consisting of (i′), (ii′), (iii′) and (iv′).
90. A catalyst for the selective catalytic reduction of NOx obtainable or obtained by a process according to any one of embodiments 20 to 56 or 57 to 89.
91. An exhaust gas treatment system for treating exhaust gas exiting a compression ignition engine, said exhaust gas treatment system having an upstream end for introducing said exhaust gas stream into said exhaust gas treatment system, wherein said exhaust gas treatment system comprises a catalyst according to any one of embodiments 1 to 19 and 90, one or more of a diesel oxidation catalyst, a selective catalytic reduction catalyst, an ammonia oxidation catalyst, a NOx trap and a particulate filter.
92. The system of embodiment 91, comprising the catalyst according to any one of embodiments 1 to 19 and 90, a diesel oxidation catalyst and a selective catalytic reduction catalyst;
   wherein the diesel oxidation catalyst preferably is located upstream of the selective catalytic reduction catalyst and the selective catalytic reduction catalyst is located upstream of the catalyst according to any one of embodiments 1 to 19 and 90.
93. The system of embodiment 91, comprising the catalyst according to any one of embodiments 1 to 19 and 90, a NOx trap and a selective catalytic reduction catalyst; wherein the NOx trap preferably is located upstream of the selective catalytic reduction catalyst and the selective catalytic reduction catalyst is located upstream of the catalyst according to any one of embodiments 1 to 19 and 90.
94. The system of embodiment 91, comprising the catalyst according to any one of embodiments 1 to 19 and 90, a diesel oxidation catalyst and a selective catalytic reduction catalyst;
   wherein the diesel oxidation catalyst preferably is located upstream of the catalyst according to any one of embodiments 1 to 19 and 90 and the catalyst according to any one of embodiments 1 to 19 and 90 is located upstream of the selective catalytic reduction catalyst.
95. The system of embodiment 91, comprising the catalyst according to any one of embodiments 1 to 19 and 90, a NOx trap and a selective catalytic reduction catalyst; wherein the NOx trap preferably is located upstream of the catalyst according to any one of embodiments 1 to 19 and 90 and the catalyst according to any one of embodiments 1 to 19 and 90 is located upstream of the selective catalytic reduction catalyst.
96. The system of embodiment 95, further comprising an ammonia oxidation catalyst or a selective catalytic reduction/ammonia oxidation catalyst, preferably located downstream of the selective catalytic reduction catalyst.
97. Use of a catalyst according to any one of embodiments 1 to 19 and 90 for the selective catalytic reduction of NOx.
98. A method for the selective catalytic reduction of NOx, the method comprising
   (1) providing an exhaust gas stream, preferably exiting a diesel engine;
   (2) contacting the exhaust gas stream provided in (1) with a catalyst for the selective catalytic reduction of NOx according to any one of embodiments 1 to 19 and 90.

Further, it is explicitly noted that the above set of embodiments represents a suitably structured part of the general description directed to preferred aspects of the present invention, and, thus, suitably supports, but does not represent the claims of the present invention.

Systems according to the present invention are listed in the Table below.

| Systems | Catalyst 1 | Catalyst 2 | Catalyst 3 | Catalyst 4 |
|---|---|---|---|---|
| 1 | DOC | SCR | Cat. | — |
| 2 | NOx trap | SCR | Cat. | — |
| 3 | DOC | Cat. | SCR | — |
| 4 | NOx trap | Cat. | SCR | (AMOx or |
| | | | | SCR/AMOx) |

Catalyst 1 is located upstream of Catalyst 2 and Catalyst 2 is located upstream of Catalyst 3 and Catalyst 3 is located upstream of Catalyst 4. In the above table, “Cat.” designates the catalyst according to the present invention, preferably wherein the substrate is a wall-flow filter substrate. Further, “DOC” designates a diesel oxidation catalyst, “SCR” a selective catalytic reduction catalyst and “AMOx” an ammonia oxidation catalyst. “Cat.” is a selective catalytic reduction catalyst on filter “SCRoF”. In the context of the present invention, systems 1 and 3 are preferred.

In the context of the present invention, the term “SCR” designates a selective catalytic reduction catalyst and the term “SCRoF” designates a selective catalytic reduction catalyst on a wall-flow filter substrate.

In the context of the present invention, the term “wherein the porous walls of the substrate comprises a coating” means that at least a portion of the coating is located within the pores of the walls of the wall-flow filter substrate.

Further, in the context of the present invention, the term “loading of a given component/coating”
(in g/in³ or g/ft³) refers to the mass of said component/coating per volume of the substrate, wherein the volume of the substrate is the volume which is defined by the cross-section of the substrate times the axial length of the substrate over which said component/coating is present. For example, if reference is made to the loading of a first coating extending over x % of the axial length of the substrate and having a loading of X g/in³, said loading would refer to X gram of the first coating per x % of the volume (in in³) of the entire substrate.

Further, in the context of the present invention, the term “based on the weight of the zeolitic material” refers to the weight of the zeolitic material alone, meaning without copper. Further, in the context of the present invention, the term “based on the weight of the Chabazite” refers to the weight of the Chabazite alone, meaning without copper.

Furthermore, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

The present invention is further illustrated by the following Examples.

### EXAMPLES

### Reference Example 1 Measurement of the BET Specific Surface Area and Micropore Surface Area (ZSA)

The BET specific surface area and ZSA was determined according to DIN 66131 or DIN-ISO 9277 using liquid nitrogen.

### Reference Example 2 Measurement of the Average Porosity and the Average Pore Size of the Porous Wall-Flow Substrate

The average porosity of the porous wall-flow substrate was determined by mercury intrusion using mercury porosimetry according to DIN 66133 and ISO 15901-1.

### Reference Example 3 Determination of the Volume-Based Particle Size Distributions

The particle size distributions were determined by a static light scattering method using Sympatec HELOS (3200) & QUIXEL equipment, wherein the optical concentration of the sample was in the range of from 6 to 10%.

### Reference Example 4: Process for Preparing a Catalyst Comprising a Zeolitic Material Comprising Copper not According to the Present Invention

A CuO powder having a Dv50 of 1.1 micrometers and a Dv90 of 5.8 micrometers was added to water. The amount of CuO was calculated such that the total amount of copper in the coating after calcination was of 4.15 weight-%, calculated as CuO, based on the weight of the Chabazite. Sucrose was further added to the Cu mixture, the amount of sucrose was calculated such that it was 4.15 weight-% based on the weight of the Chabazite. Acetic acid was added to the obtained slurry. The amount of acetic acid was calculated such that it was 1.7 weight-% based on the weight of the Cu-Chabazite. The resulting slurry had a solid content of 5 weight-% based on the weight of said slurry. An aqueous zirconium acetate solution was added to the CuO-containing mixture forming a slurry. The amount of zirconium acetate was calculated such that the amount of zirconia in the coating, calculated as ZrO₂, was 5 weight-% based on the weight of the Chabazite. A H-Chabazite (Dv10 of 0.7 micrometers, Dv50 of 1.5 micrometers, and a Dv90 of 3.9 micrometers, a SiO₂:Al₂O₃ of 15.7:1, a BET specific surface area of 590 m²/g and a micropore surface area (ZSA) of 580 m²/g) was added to the copper containing slurry to form a mixture having a solid content of 37 weight-% based on the weight of said mixture. The amount of the Chabazite was calculated such that the loading of Chabazite after calcination was 85% of the loading of the coating in the catalyst after calcination. The resulting slurry was milled using a continuous milling apparatus so that the Dv90 value of the particles was of about 2.5 micrometers and the Dv50 value of the particles was of about 1.35 micrometers.

An alumina powder (Al₂O₃ 94 weight-% with SiO₂ 6 weight-% having a BET specific surface area of 178 m²/g, a Dv10 of 1.1 micrometers, a Dv50 of 2.5 micrometers, and a Dv90 of about 5.2 micrometers) was added to the Cu/CHA containing slurry. The amount of alumina+silica was calculated such that the amount of alumina+silica after calcination was 10 weight-% based on the weight of the Chabazite after calcination in the final catalyst.

Further, the solid content of the final slurry was adjusted to 34 weight-% based on the weight of said slurry by addition of water.

A porous uncoated wall-flow filter substrate, silicon carbide, (volume: 0.428 L, an average porosity of 63%, a mean pore size of 20 micrometers and 300 cpsi and 12 mil wall thickness, diameter: 2.3 inches*length: 6.4 inches) was coated twice from the inlet end to the outlet end with the final slurry over 100% of the substrate axial length. To do so, the substrate was dipped in the final slurry from the inlet end until the slurry arrived at the top of the substrate. Further a pressure pulse was applied on the inlet end to distribute the slurry evenly in the substrate. Further, the coated substrate was dried at 140° C. for 30 minutes and calcined at 450° C. for 1 hour. This was repeated once.

The final coating loading after calcinations was about 2.0 g/in³, including about 1.7 g/in³ of Chabazite, 0.17 g/in³ of alumina+silica, 0.085 g/in³ of zirconia and 4.15 weight-% of Cu, calculated as CuO, based on the weight of the Chabazite. The weight ratio of the zeolitic material to zirconia in the coating is of 20:1.

### Reference Example 5: Process for Preparing a Catalyst Comprising a Zeolitic Material Comprising Copper not According to the Present Invention

The catalyst of Reference Example 5 was prepared as the catalyst of Reference Example 4, except that the amount of zirconium acetate was calculated such that the amount of zirconia in the coating, calculated as ZrO₂, was 2.5 weight-% based on the weight of the Chabazite. The final coating loading after calcinations was about 2.05 g/in³, including about 1.75 g/in³ of Chabazite, 0.175 g/in³ of alumina+silica, 0.044 g/in³ of zirconia and 4.15 weight-% of Cu, calculated as CuO, based on the weight of the Chabazite. The weight ratio of the zeolitic material to zirconia in the coating is of 40:1.

### Example 1: Process for Preparing a Catalyst Comprising a Zeolitic Material Comprising Copper According to the Present Invention

The catalyst of Example 1 was prepared as the catalyst of Reference Example 4 except that the amount of zirconium acetate have been increased in the process such that the amount of zirconium acetate was calculated such that the amount of zirconia in the coating, calculated as ZrO₂, was 10 weight-% based on the weight of the Chabazite. The final coating loading after calcinations was about 2.0 g/in³, including about 1.65 g/in³ of Chabazite, 0.165 g/in³ of alumina+silica, 0.165 g/in³ of zirconia and 4.15 weight-% of Cu, calculated as CuO, based on the weight of the Chabazite. The weight ratio of the zeolitic material to zirconia in the coating is of 10:1.

### Example 2: Testing the Performance of the Prepared Catalysts of Reference Examples 4, 5 and of Example 1

Coldflow backpressure measurements were done for the tested catalysts and backpressure measurements with soot were done on the engine bench with the fresh catalysts. For analysis of DeNOx activity technologies, the tested catalysts were oven aged for 16 h at 850° C. with 10% H₂O and 20% O₂. For evaluation engine bench tests were performed in steady state conditions were done. The tested catalysts are listed in Table 1.

TABLE 1

| | Brief description of | Final coating | Coldflow delta p |
|---|---|---|---|
| Catalysts | the catalysts | loading (g/in³) | (mbar) |
| Ref. Ex. 4 | 1.7 g/n³ of CHA | 2 | 53 |
| | 0.17 of silica/alumina | | |
| | 5 wt. %* zirconia | | |
| Ref. Ex. 5 | 1.75 g/n³ of CHA | 2.05 | 55 |
| | 0.175 of silica/ | | |
| | alumina | | |
| | 2.5 wt. %* zirconia | | |
| Example 1 | 1.65 g/n³ of CHA | 2.05 | 50 |
| | 0.165 of silica/ | | |
| | alumina | | |
| | 10 wt. %* zirconia | | |

*based on the weight of the Chabazite

FIGS. 1 and 2 show the test results in NOx performance (1a), NOx performance at 20 ppm NH₃ break through (1b) and backpressure behavior under steady state conditions.

Example 1 presents comparable DeNOx activities compared with Reference Examples 4 and 5 and reduced backpressure. Thus, the catalyst of the present invention permits to maintain great catalytic performance such as DeNOx while reducing backpressure.

FIG. 3 shows the test results in backpressure with soot conditions from the engine bench. Example 1 (10 wt.-% ZrO₂) shows the most promising results especially in the backpressure with soot behavior. It shows close to 25% lower backpressure with soot compared with Reference Example 1.

### Reference Example 6: Process for Preparing a Catalyst Comprising a Zeolitic Material Comprising Copper not According to the Present Invention

The catalyst of Reference Example 6 was prepared as the catalyst of Reference Example 4, except that a full-size substrate has been added. In particular, the substrate used is a porous uncoated wall-flow filter substrate, silicon carbide, (volume: 3 L, an average porosity of 63%, a mean pore size of 20 micrometers and 300 cpsi and 12 mil wall thickness, diameter: 6.43 inches*length: 6.387 inches). The final coating loading after calcinations was about 2 g/in³, including about 1.71 g/in³ of Chabazite, 0.171 g/in³ of alumina+silica, 0.085 g/in³ of zirconia and 4.15 weight-% of Cu, calculated as CuO, based on the weight of the Chabazite. The weight ratio of the zeolitic material to zirconia in the coating is of 20:1.

### Example 3: Process for Preparing a Catalyst Comprising a Zeolitic Material Comprising Copper According to the Present Invention

The catalyst of Example 3 was prepared as the catalyst of Example 1, except that a full-size substrate has been added. In particular, the substrate used is a porous uncoated wall-flow filter substrate, silicon carbide, (volume: 3 L, an average porosity of 63%, a mean pore size of 20 micrometers and 300 cpsi and 12 mil wall thickness, diameter: 6.43 inches*length: 6.387 inches). The final coating loading after calcinations was about 2 g/in³, including about 1.63 g/in³ of Chabazite, 0.163 g/in³ of alumina+silica, 0.163 g/in³ of zirconia and 4.15 weight-% of Cu, calculated as CuO, based on the weight of the Chabazite. The weight ratio of the zeolitic material to zirconia in the coating is of 10:1.

### Example 4: Process for Preparing a Catalyst Comprising a Zeolitic Material Comprising Copper According to the Present Invention

The catalyst of Example 4 was prepared as the catalyst of Example 3 except that the amount of zirconium acetate has been increased in the process such that the amount of zirconium acetate was calculated such that the amount of zirconia in the coating, calculated as ZrO₂, was 20 weight-% based on the weight of the Chabazite. The final coating loading after calcinations was about 2 g/in³, including about 1.51 g/in³ of Chabazite, 0.151 g/in³ of alumina+silica, 0.302 g/in³ of zirconia and 4.15 weight-% of Cu, calculated as CuO, based on the weight of the Chabazite. The weight ratio of the zeolitic material to zirconia in the coating is of 5:1.

### Example 5: Testing the Performance of the Prepared Catalysts of Reference Example 6 and of Examples 3 and 4

Backpressure measurements with soot loading were done on laboratory conditions with fresh catalysts (non-aged). For analysis of DeNOx activity and NH₃ storage capacity, the catalysts were oven aged for 16 h at 850° C. with 10% H₂O and 20% O₂ (FIG. 6) and the catalyst were oven aged for 16 h at 850° C., then for 16 h at 800° C. and finally for 16 h at 850° C. with 10% H₂O and 20% O₂ (FIG. 7). For evaluation, engine bench tests in steady state conditions were done. The tested catalysts are listed in Table 2.

TABLE 2

| | Brief description of | Final coating |
|---|---|---|
| Catalysts | the catalysts | loading (g/in³) |
| Ref. Ex. 6 | 1.71 g/n³ of CHA | 2 |
| | 0.171 of silica/ | |
| | alumina | |
| | 5 wt. %* zirconia | |
| Example 3 | 1.63 g/n3 of CHA | 2 |
| | 0.163 of silica/ | |
| | alumina | |
| | 10 wt. %* zirconia | |
| Example 4 | 1.51 g/n3 of CHA | 2 |
| | 0.151 of silica/ | |
| | alumina | |
| | 20 wt. %* zirconia | |

*based on the weight of the Chabazite

FIG. 4 shows the test results in cold flow conditions and the backpressure behavior with soot loading from the laboratory reactor. It is noted that the backpressure with soot-loading is significant reduced when using the catalysts of the present invention which comprises higher proportions of zirconia compared to the catalyst of Reference Example 6. In particular, the catalyst with 20 wt.-% ZrO₂ shows a reduced cold flow backpressure (−15%) and reduced soot loaded backpressure of about 44% at 4 g/L soot compared to Reference Example 6.

Engine bench evaluation shows equivalent DeNOx activity of the inventive Examples 3 and 4 vs. Reference Example 6 after aging for 16 h at 850° C. (FIG. 5a-b). The reduced NH₃ storage capacity visible on FIG. 6 is the consequence of the reduced zeolitic material amount but does not hurt the DeNOx activity. Without wanting to be bound to any theories, it is believed that when increasing the thermal aging conditions to longer time (3 ageing steps as described above) and harsher conditions (higher flow from 5 to 25 I/h during the ageing step, more H₂O), the zeolitic material becomes stabilized by increasing the zirconia amount. This is illustrated with a better SCR activity and a higher NH₃ storage capacity after strong hydrothermal aging (see FIGS. 6-7).

### Example 6

A) Process for Preparing a Catalyst Comprising a Zeolitic Material Comprising copper according to the present invention:

The catalyst of Example 6A was prepared as the catalyst of Example 4 except that the substrate used is a porous uncoated wall-flow filter substrate, silicon carbide, (volume: 3.4 L, an average porosity of 63%, a mean pore size of 20 micrometers and 300 cpsi and 12.5 mil wall thickness, diameter: 163.4 mm*length: 162.1 mm). The final coating loading after calcinations was about 2 g/in³, including about 1.51 g/in³ of Chabazite, 0.151 g/in³ of alumina+silica, 0.302 g/in³ of zirconia and 4.15 weight-% of Cu, calculated as CuO, based on the weight of the Chabazite. The weight ratio of the zeolitic material to zirconia in the coating is of 5:1.

### B) Process for Preparing a Catalyst Comprising a Zeolitic Material Comprising Copper According to the Present Invention:

The catalyst of Example 6B was prepared as the catalyst of Example 6A, except that the amount of CuO was calculated such that the total amount of copper in the coating after calcination was of 4.5 weight-%, calculated as CuO, based on the weight of the Chabazite. The final coating loading after calcinations was about 2 g/in³, including about 1.51 g/in³ of Chabazite, 0.151 g/in³ of alumina+silica, 0.302 g/in³ of zirconia and 4.5 weight-% of Cu, calculated as CuO, based on the weight of the Chabazite. The weight ratio of the zeolitic material to zirconia in the coating is of 5:1.

### Reference Example 7

### A) Process for Preparing a Catalyst Comprising a Zeolitic Material Comprising Copper not According to the Present Invention:

The catalyst of Reference Example 7A was prepared as the catalyst of Reference Example 6, except that the substrate used is a porous uncoated wall-flow filter substrate, silicon carbide (NGK), (volume: 3.4 L, an average porosity of 63%, a mean pore size of 20 micrometers and 300 cpsi and 12.5 mil wall thickness, diameter: 163.4 mm*length: 162.1 mm). The final coating loading after calcinations was about 2 g/in³, including about 1.71 g/in³ of Chabazite, 0.171 g/in³ of alumina+silica, 0.085 g/in³ of zirconia and 4.15 weight-% of Cu, calculated as CuO, based on the weight of the Chabazite. The weight ratio of the zeolitic material to zirconia in the coating is of 20:1.

### B) Process for Preparing a Catalyst Comprising a Zeolitic Material Comprising Copper not According to the Present Invention:

The catalyst of Reference Example 7B was prepared as the catalyst of Reference Example 6, except that the substrate used is a porous uncoated wall-flow filter substrate, aluminum titanate (volume: 3.6 L, an average porosity of 59%, a mean pore size of 18 micrometers and 350 cpsi and 12 mil wall thickness, diameter: 163.4 mm*length: 162.1 mm). The final coating loading after calcinations was about 2 g/in³, including about 1.71 g/in³ of Chabazite, 0.171 g/in³ of alumina+silica, 0.085 g/in³ of zirconia and 4.15 weight-% of Cu, calculated as CuO, based on the weight of the Chabazite. The weight ratio of the zeolitic material to zirconia in the coating is of 20:1.

### Example 7

### A) Process for Preparing a Catalyst Comprising a Zeolitic Material Comprising Copper According to the Present Invention:

The final slurry for Example 7A was prepared as for Example 4. Further, a porous uncoated wall-flow filter substrate, silicon carbide, (volume: 3.4 L, an average porosity of 63%, a mean pore size of 20 micrometers and 300 cpsi and 12.5 mil wall thickness, diameter: 163.4 mm*length: 162.1 mm) was coated from the inlet end to the outlet end with the final slurry over 70% of the substrate axial length. To do so, the substrate was dipped in the final slurry from the outlet end until the slurry arrived at 70% of the substrate axial length. Further a pressure pulse was applied on the inlet end to distribute the slurry evenly in the substrate. Further, the coated substrate was dried at 140° C. for 30 minutes and calcined at 450° C. for 1 hour, forming a first coat (inlet coat) at a loading of 1.43 g/in³. Further, the coated substrate was coated from the inlet end to the outlet end with the final slurry over 70% of the substrate axial length. To do so, the substrate was dipped in the final slurry from the inlet end until the slurry arrived at 70% of the substrate axial length. Further a pressure pulse was applied on the outlet end to distribute the slurry evenly in the substrate. Further, the coated substrate was dried at 140° C. for 30 minutes and calcined at 450° C. for 1 hour, forming a second coat (outlet coat) at a loading of 1.43 g/in³.

The final coating loading (inlet coat+outlet coat) after calcinations was about 2 g/in³, including about 1.51 g/in³ of Chabazite, 0.151 g/in³ of alumina+silica, 0.302 g/in³ of zirconia and 4.15 weight-% of Cu, calculated as CuO, based on the weight of the Chabazite. The weight ratio of the zeolitic material to zirconia in the coating is of 5:1.

### B) Process for Preparing a Catalyst Comprising a Zeolitic Material Comprising Copper According to the Present Invention:

The catalyst of Example 7B was prepared as the catalyst of Example 7A, except that the substrate used is a porous uncoated wall-flow filter substrate, aluminum titanate, (volume: 3.6 L, an average porosity of 59%, a mean pore size of 18 micrometers and 350 cpsi and 12 mil wall thickness, diameter: 163.4 mm*length: 162.1 mm). The final coating loading (inlet coat+outlet coat) after calcinations was about 2 g/in³, including about 1.51 g/in³ of Chabazite, 0.151 g/in³ of alumina+silica, 0.302 g/in³ of zirconia and 4.15 weight-% of Cu, calculated as CuO, based on the weight of the Chabazite. The weight ratio of the zeolitic material to zirconia in the coating is of 5:1.

### Example 8

### A) Process for Preparing a Catalyst Comprising a Zeolitic Material Comprising Copper According to the Present Invention:

The final slurry for Example 8 was prepared as for Example 4, except that the amount of CuO was calculated such that the total amount of copper in the coating after calcination was of 4.5 weight-%, calculated as CuO, based on the weight of the Chabazite. Further, a porous uncoated wall-flow filter substrate, silicon carbide, (volume: 3.4 L, an average porosity of 59%, a mean pore size of 18 micrometers and 350 cpsi and 12 mil wall thickness, diameter: 163.4 mm*length: 162.1 mm) was coated once from the inlet end to the outlet end with the final slurry over 100% of the substrate axial length. To do so, the substrate was dipped in the final slurry from the inlet end until the slurry arrived at the top of the substrate. Further a pressure pulse was applied on the inlet end to distribute the slurry evenly in the substrate. Further, the coated substrate was dried at 140° C. for 30 minutes and calcined at 450° C. for 1 hour. The final coating loading after calcinations was about 2 g/in³, including about 1.51 g/in³ of Chabazite, 0.151 g/in³ of alumina+silica, 0.302 g/in³ of zirconia and 4.5 weight-% of Cu, calculated as CuO, based on the weight of the Chabazite. The weight ratio of the zeolitic material to zirconia in the coating is of 5:1.

### B) Process for Preparing a Catalyst Comprising a Zeolitic Material Comprising Copper According to the Present Invention:

The catalyst of Example 8B was prepared as the catalyst of Example 8A, except that the substrate used is a porous uncoated wall-flow filter substrate silicon carbide, (volume: 3.4 L, an average porosity of 63%, a mean pore size of 20 micrometers and 300 cpsi and 12 mil wall thickness, diameter: 163.4 mm*length: 162.1 mm). The final coating loading after calcinations was about 2 g/in³, including about 1.51 g/in³ of Chabazite, 0.151 g/in³ of alumina+silica, 0.302 g/in³ of zirconia and 4.5 weight-% of Cu, calculated as CuO, based on the weight of the Chabazite. The weight ratio of the zeolitic material to zirconia in the coating is of 5:1.

### Example 9: Testing the Performance of the Prepared Catalysts of Reference Examples 7A-B and of Examples 6A-B, 7A-B and 8

Cold flow backpressure measurements were done on laboratory conditions with fresh catalysts (non-aged) of Reference Examples 7A and 7B and of Examples 6A, 7A, 7B and 8A. The results are presented in Table 3 below. For analysis of DeNOx activity, the catalysts of Reference Example 7A and Examples 6A, 6B and 8B were oven aged for 16 h at 850° C. with 10% H₂O and 20% O₂ (FIGS. 8 and 9). For evaluation, engine bench tests in steady state conditions were done.

TABLE 3
Coldflow backpressure

| | | Coldflow |
|---|---|---|
| | Substrate/Coating/ZrO2-content | backpressure |
| Catalysts | (wt.-%) | (mbar) |
| Ref. Ex. 7A | SiC/2 inlet coats (100%)/5 | 60 |
| Example 6A | SiC/2 inlet coats (100%)/20 | 50 |
| Example 7A | SiC/outlet coat (70%) + inlet coat | 46 |
| | (70%)/20 | |
| Ref. Ex. 7B | Al2TiO5/2 inlet coats (100%)/5 | 45 |
| Example 8A | Al2TiO5/one inlet coat (100%)/20 | 42.5 |
| Example 7B | Al2TiO5/outlet coat (70%) + inlet | 35 |
| | coat (70%)/20 | |

FIGS. 8 and 9 shows results from engine bench evaluation. Example 6A shows equivalent maximal DeNOx activity and DeNOx activity at 20 ppm NH₃ breakthrough compared with the Ref. Example 7A over the complete temperature window while the cold flow backpressure of the catalyst of Example 6A is reduced. Thus, without wanting to be bound to any theory, it is believed that the reduced zeolite amount by increasing the Zr-amount does not hurt DeNOx activity and even permits to decrease the backpressure. Example 6B and Example 8B show slightly higher low temperature DeNOx activity and slightly higher DeNOx activity at 20 ppm NH₃ breakthrough due to the higher CuO loading. High temperature performance is equivalent to Ref. Ex. 7A and Example 6A.

### Example 10: Process for Preparing Catalysts Comprising a Zeolitic Material Comprising Copper According to the Present Invention

### Preparing the Catalysts:

The catalyst of Example 10.1 was prepared as the catalyst of Example 1, except that the amount of zirconium acetate have been increased in the process such that the amount of zirconium acetate was calculated such that the amount of zirconia in the coating, calculated as ZrO₂, was 20 weight-% based on the weight of the Chabazite and that the amount of CuO was calculated such that the total amount of copper in the coating after calcination was of 4.5 weight-%, calculated as CuO, based on the weight of the Chabazite. The final coating loading after calcinations was about 2 g/in³, including about 1.49 g/in³ of Chabazite, 0.149 g/in³ of alumina+silica, 0.3 g/in³ of zirconia and 4.5 weight-% of Cu, calculated as CuO, based on the weight of the Chabazite. The weight ratio of the zeolitic material to zirconia in the coating is of 4.9:1.

The catalyst of Example 10.2 was prepared as the catalyst of Example 1, except that the amount of zirconium acetate have been increased in the process such that the amount of zirconium acetate was calculated such that the amount of zirconia in the coating, calculated as ZrO₂, was 25 weight-% based on the weight of the Chabazite. The final coating loading after calcinations was about 2 g/in³, including about 1.44 g/in³ of Chabazite, 0.144 g/in³ of alumina+silica, 0.36 g/in³ of zirconia and 4.15 weight-% of Cu, calculated as CuO, based on the weight of the Chabazite. The weight ratio of the zeolitic material to zirconia in the coating is of 4:1.

The catalyst of Example 10.3 was prepared as the catalyst of Example 1, except that the amount of zirconium acetate have been increased in the process such that the amount of zirconium acetate was calculated such that the amount of zirconia in the coating, calculated as ZrO₂, was 40 weight-% based on the weight of the Chabazite. The final coating loading after calcinations was about 2 g/in³, including about 1.3 g/in³ of Chabazite, 0.13 g/in³ of alumina+silica, 0.52 g/in³ of zirconia and 4.15 weight-% of Cu, calculated as CuO, based on the weight of the Chabazite. The weight ratio of the zeolitic material to zirconia in the coating is of 2.5:1.

TABLE 4

| | Brief description of the | Final coating loading |
|---|---|---|
| Catalysts | catalysts | (g/in³) |
| Ref. Ex. 4 | CHA | 2 |
| | 4.15 wt. %* CuO | |
| | 5 wt. %* zirconia | |
| Ref. Ex. 4′ | CHA | 2 |
| | 4.5 wt. %* CuO | |
| | 5 wt. %* zirconia | |
| Ex. 10.1 | CHA | 2 |
| | 4.5 wt. %* CuO | |
| | 20 wt. %* zirconia | |
| Ex. 10.2 | CHA | 2 |
| | 4.15 wt. %* CuO | |
| | 25 wt. %* zirconia | |
| Ex. 10.3 | CHA | 2 |
| | 4.15 wt. %* CuO | |
| | 40 wt. %* zirconia | |

*based on the weight of the Chabazite

### Testing the Catalytic Performance of the Prepared Catalysts:

Backpressure measurements were done on laboratory conditions with fresh catalysts (non-aged) of Examples 10.1, 10.2 and 10.3. The backpressure was also measured for a reference catalyst (Ref. Ex. 4′) not according to the present invention which has been prepared as Ref. Example 4 except that the Cu amount was of 4.5 weight-% based on the weight of the zeolitic material. The results are presented on FIG. 12.

For analysis of DeNOx activity, the catalysts of Reference Example 4 and Examples 10.1, 10.2 and 10.3 were oven aged for 16 h at 850° C. with 10% H₂O and 20% O₂ (see FIGS. 13 and 14). For evaluation, engine bench tests in steady state conditions were done.

As may be taken from FIGS. 12, 13 and 14, Example 10.1 shows a significant reduced backpressure behavior with soot compared with Ref. Example 4′. Additional zeolite reduction to Example 10.1 leads to a further lowering in backpressure. The reduced zeolite loading especially of Example 10.3 impacts the maximal DeNOx activity and the DeNOx activity at 20 ppm NH₃ breakthrough due to the lower NH₃ storage capacity but stays on an acceptable good performance related to the used zeolite amount.

### Example 11: Process for Preparing Catalysts Comprising a Zeolitic Material Comprising Copper According to the Present Invention

### Preparing the Catalysts:

The catalyst of Example 11.1 was prepared as the catalyst o Example 1, except that the amount of zirconium acetate has been increased in the process such that the amount of zirconium acetate was calculated such that the amount of zirconia in the coating, calculated as ZrO₂, was 20 weight-% based on the weight of the Chabazite. The final coating loading after calcinations was about 2 g/in³, including about 1.49 g/in³ of Chabazite, 0.149 g/in³ of alumina+silica, 0.3 g/in³ of zirconia and 4.15 weight-% of Cu, calculated as CuO, based on the weight of the Chabazite. The weight ratio of the zeolitic material to zirconia in the coating is of 4.9:1.

The catalyst of Example 11.2 was prepared as the catalyst o Example 1, except that the amount of zirconium acetate has been increased in the process such that the amount of zirconium acetate was calculated such that the amount of zirconia in the coating, calculated as ZrO₂, was 50 weight-% based on the weight of the Chabazite. The final coating loading after calcinations was about 2 g/in³, including about 1.22 g/in³ of Chabazite, 0.122 g/in³ of alumina+silica, 0.61 g/in³ of zirconia and 4.15 weight-% of Cu, calculated as CuO, based on the weight of the Chabazite. The weight ratio of the zeolitic material to zirconia in the coating is of 2:1.

The catalyst of Example 11.3 was prepared as the catalyst o Example 1, except that the amount of zirconium acetate has been increased in the process such that the amount of zirconium acetate was calculated such that the amount of zirconia in the coating, calculated as ZrO₂, was 80 weight-% based on the weight of the Chabazite. The final coating loading after calcinations was about 2 g/in³, including about 1.09 g/in³ of Chabazite, 0.109 g/in³ of alumina+silica, 0.872 g/in³ of zirconia and 4.15 weight-% of Cu, calculated as CuO, based on the weight of the Chabazite. The weight ratio of the zeolitic material to zirconia in the coating is of 1.25:1.

TABLE 5

| | Brief description of the | Final coating loading |
|---|---|---|
| Catalysts | catalysts | (g/in³) |
| Ex. 11.1 | CHA | 2 |
| | 4.15 wt. %* CuO | |
| | 20 wt. %* zirconia | |
| Ex. 11.2 | CHA | 2 |
| | 4.15 wt. %* CuO | |
| | 50 wt. %* zirconia | |
| Ex. 11.3 | CHA | 2 |
| | 4.15 wt. %* CuO | |
| | 80 wt. %* zirconia | |

*based on the weight of the Chabazite

### Testing the Catalytic Performance of the Prepared Catalysts:

Backpressure measurements were done on laboratory conditions with fresh catalysts (non-aged) of Examples 11.1, 11.2 and 11.3. The results are presented on FIG. 17(a). For analysis of DeNOx activity, the catalysts of Examples 11.1, 11.2 and 11.3 were oven aged for 16 h at 850° C., 25 L flow, with 20% 02 and 2.42 ml/min of H₂O (see FIGS. 15 and 16). Backpressure was also measured on fresh conditions with the catalysts (see FIG. 17(b)). For evaluation, engine bench tests in steady state conditions were done. As may be taken from FIGS. 15-17, the backpressure measured for the catalysts of Examples 11.1, 11.2 and 11.3 is reduced compared to the catalyst of Reference Example 4′ and the catalysts of Examples 11.1, 11.2 and 11.3 exhibit great NOx conversion.

### BRIEF DESCRIPTION OF THE FIGURES

FIG. 1 shows the NOx conversion maximal (a) and the NOx conversion at 20 ppm ammonia slip (b) obtained for the aged catalysts of Ref. Examples 1, 2 and Example 1 at different temperatures.

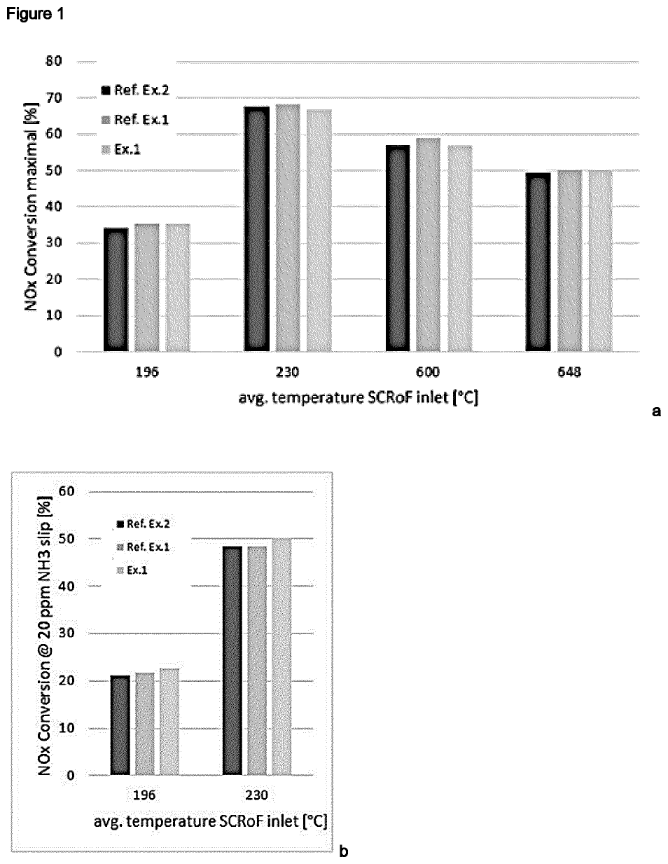

FIG. 2 shows the NH₃ storage capacity (a) and the backpressure (b) obtained for the aged catalysts of Ref. Examples 1, 2 and Example 1 at different temperatures.

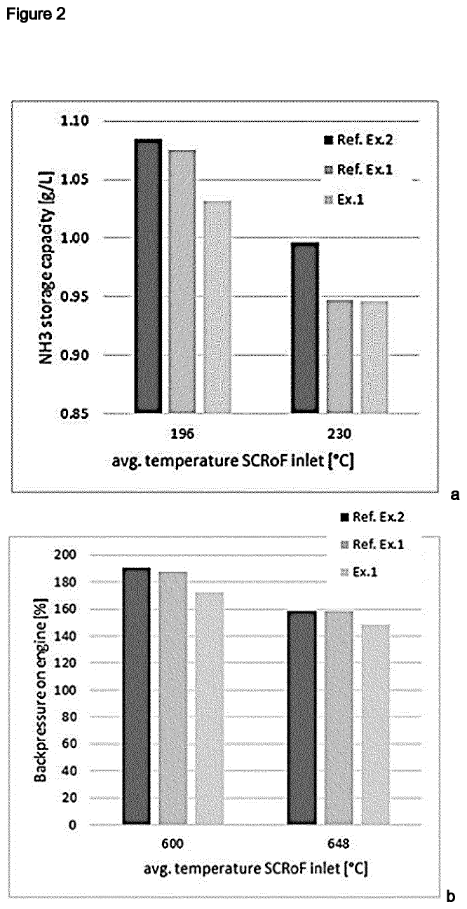

FIG. 3 shows the backpressure with soot loading ranging from 0 to 2 g/L obtained with the fresh catalysts of Ref. Example 1 and Example 1.

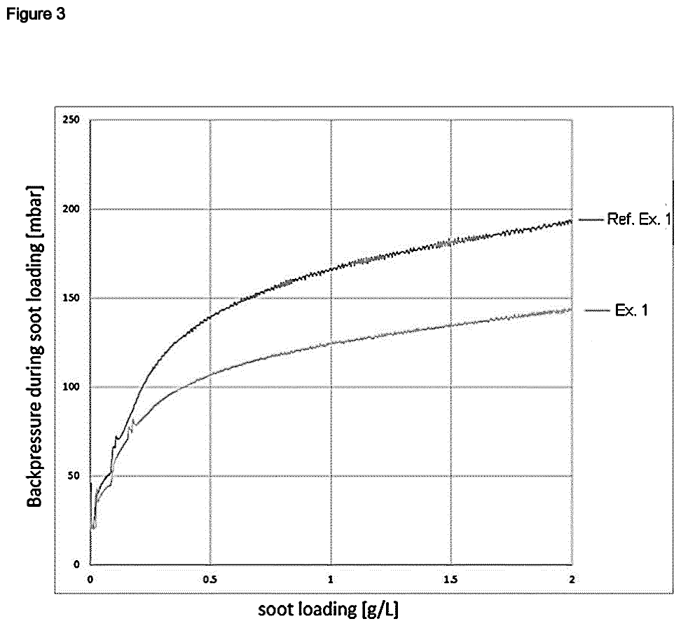

FIG. 4 shows the cold flow backpressure and backpressure with soot loading of 2, 4 and 6 g/L obtained with the fresh catalysts of Ref. Example 6 and Examples 3 and 4.

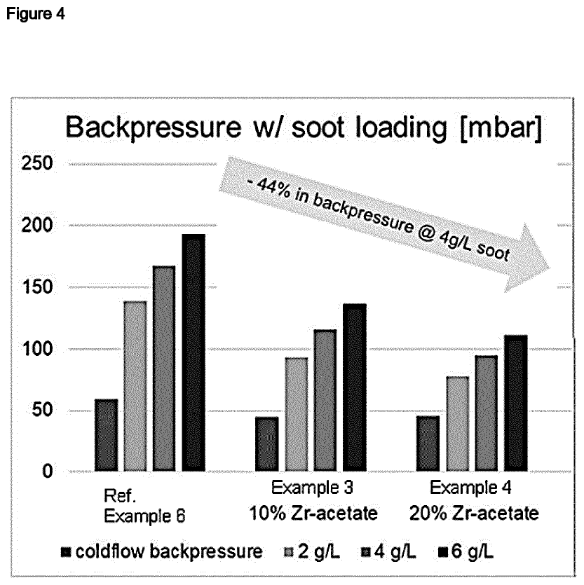

FIG. 5 shows the NOx conversion maximal (a) and the NOx conversion at 20 ppm ammonia slip (b) obtained for the aged catalysts of Ref. Example 6 and Examples 3 and 4 at different temperatures.

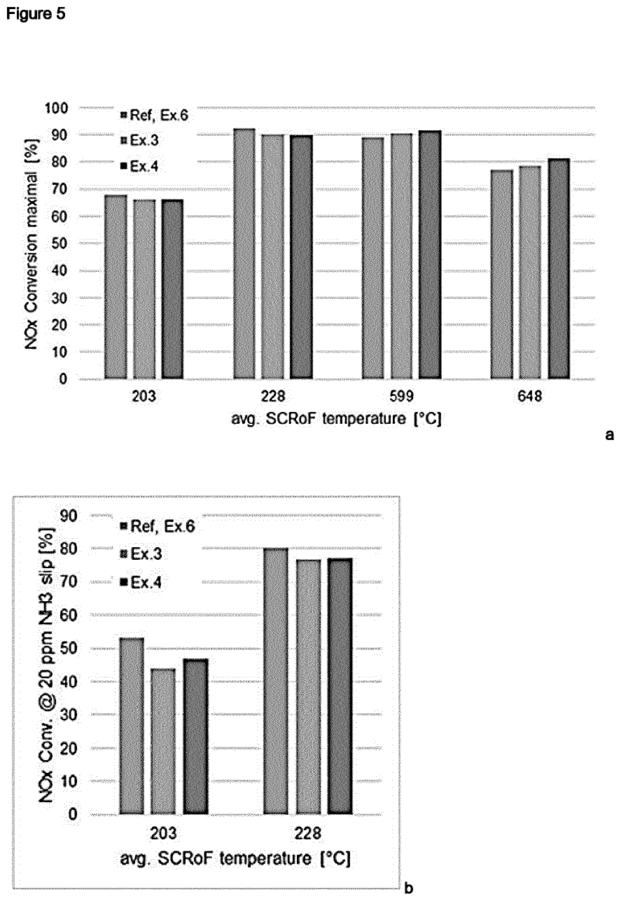

FIG. 6 shows the NOx conversion maximal (a) and the NOx conversion at 20 ppm ammonia slip (b) obtained for the aged catalysts (aged three times) of Ref. Example 6 and Examples 3 and 4 at different temperatures.

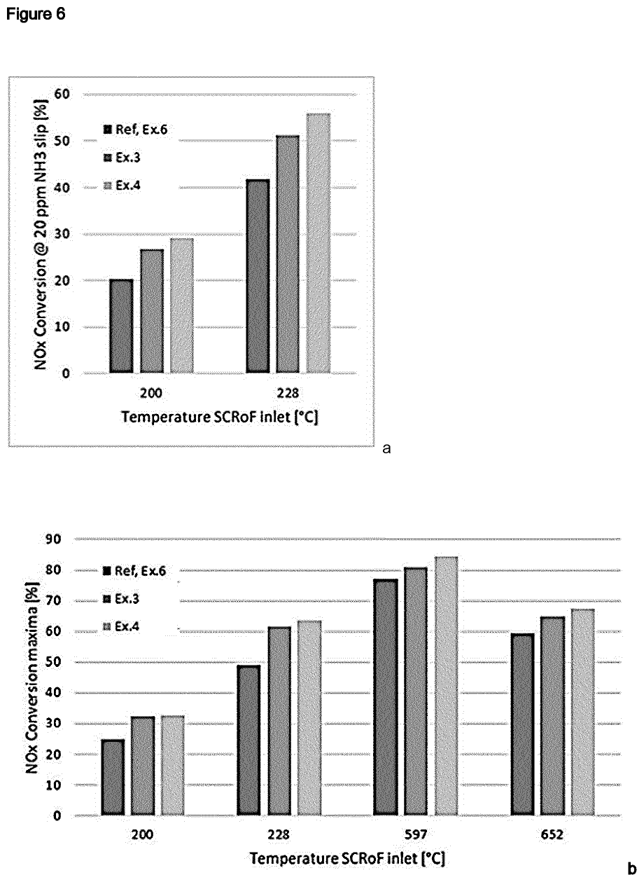

FIG. 7 shows the NH₃ storage capacity obtained for the aged catalysts (aged three times) of Ref. Example 6 and Examples 3 and 4.

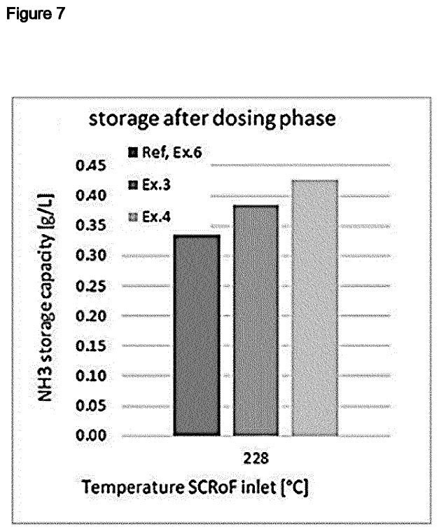

FIG. 8 shows the NOx conversion (maximal) obtained for the aged catalysts of Ref. Example 7A and Examples 6A, 6B and 8B at different temperatures.

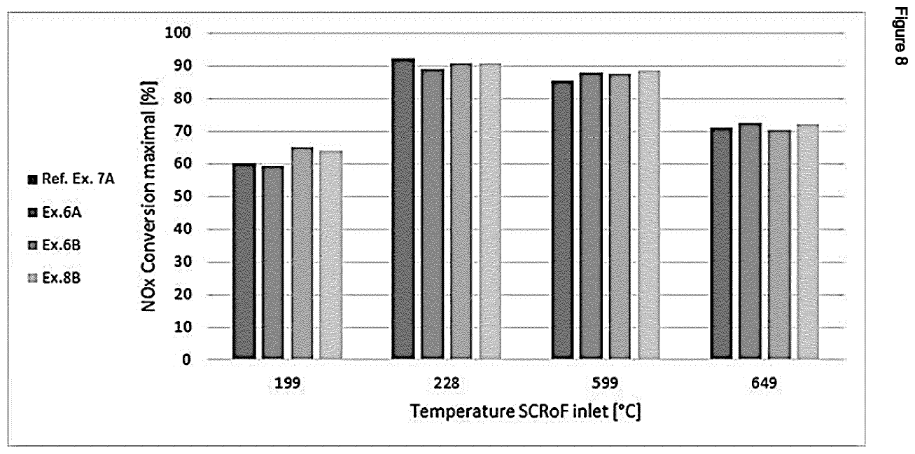

FIG. 9 shows the NOx conversion at 20 ppm ammonia slip obtained for the aged catalysts of Ref. Example 7A and Examples 6A, 6B and 8B at different temperatures.

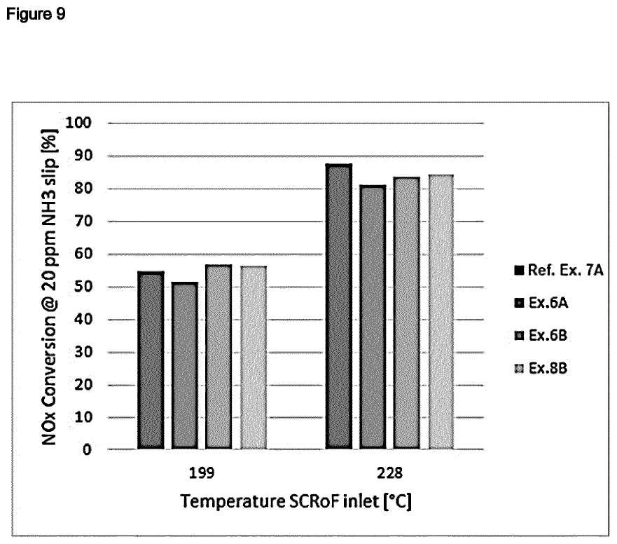

FIG. 10 shows SEM images (a) and (b) of the catalyst of Reference Example 4.

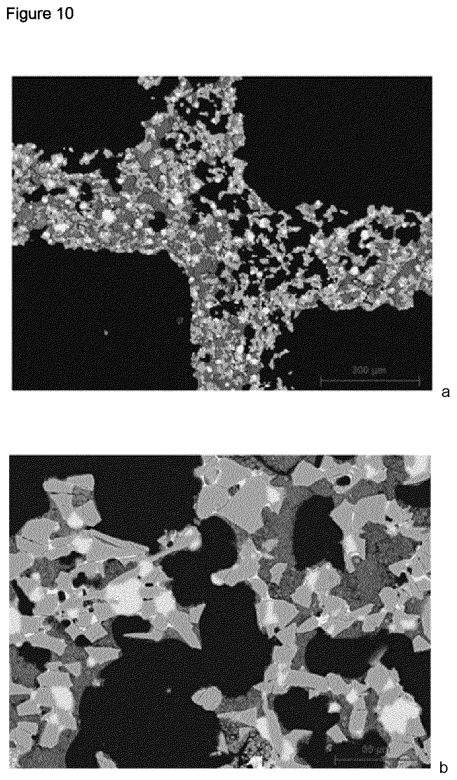

FIG. 11 shows SEM images (a) and (b) of the catalyst of Example 6A.

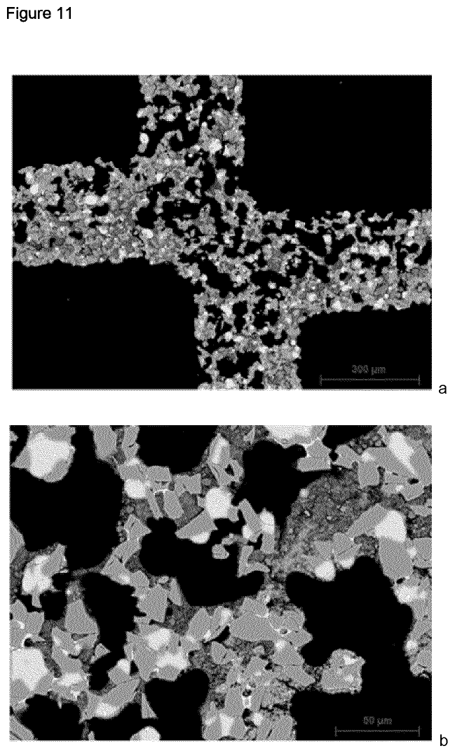

FIG. 12 shows the backpressure measured for the fresh catalysts of Ref. Ex. 4′, Examples 10.1, 10.2 and 10.3.

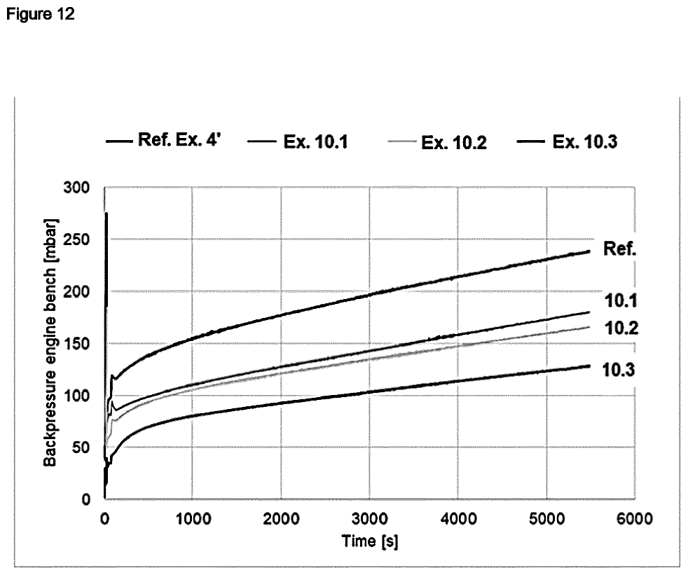

FIG. 13 shows the NOx conversion maximal (a) and the NOx conversion at 20 ppm ammonia slip (b) obtained for the aged catalysts of Ref. Example 4 and Examples 10.1, 10.2 and 10.3 at different temperatures.

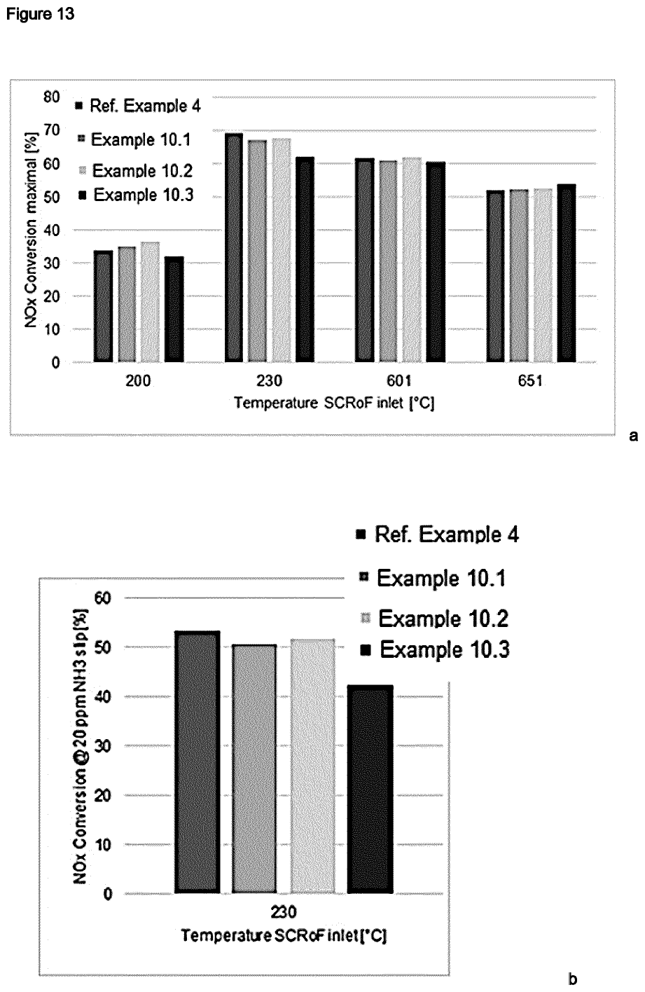

FIG. 14 shows the NH₃ storage capacity obtained for the aged catalysts of Ref. Example 4 and Examples 10.1, 10.2 and 10.3.

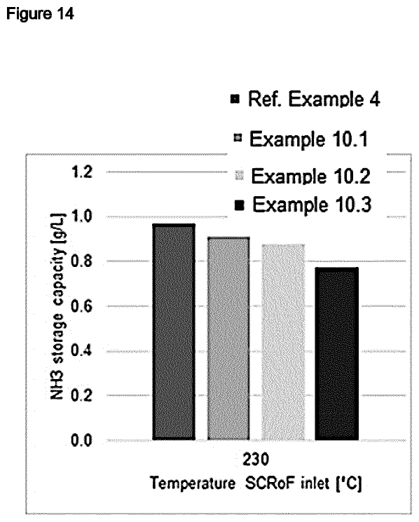

FIG. 15 shows the NOx conversion maximal (a) and the NOx conversion at 20 ppm ammonia slip (b) obtained for the aged catalysts of Examples 11.1, 11.2 and 11.3.

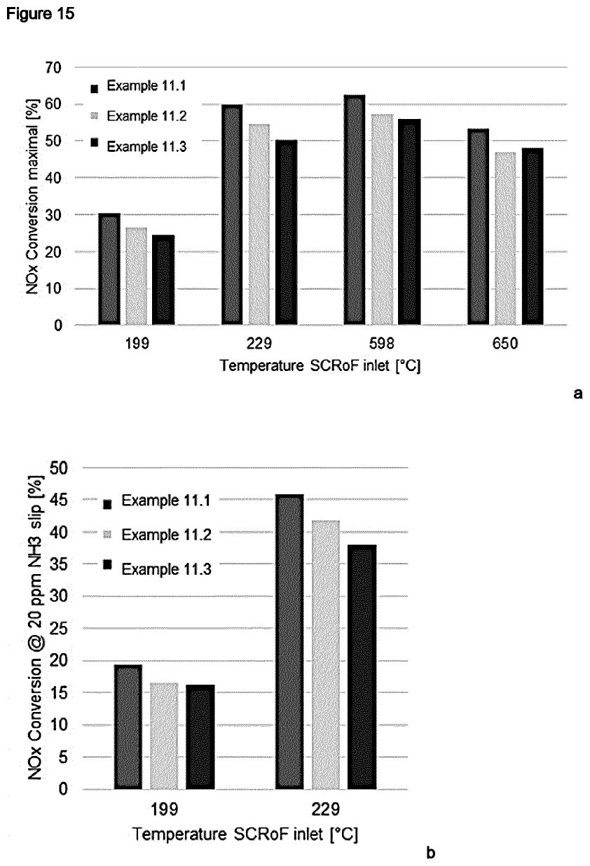

FIG. 16 shows the NH₃ storage capacity obtained for the aged catalysts of Examples 11.1, 11.2 and 11.3.

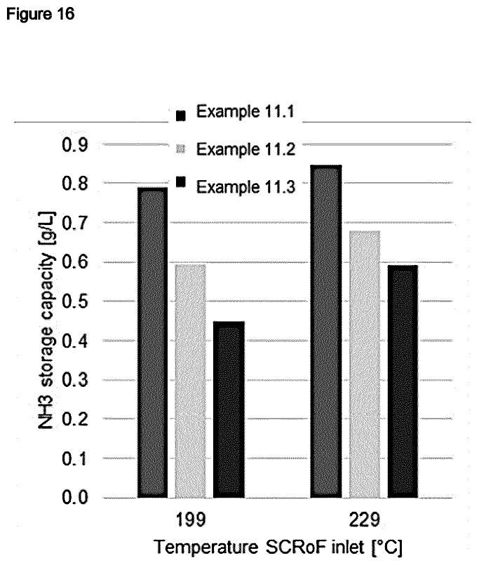

FIG. 17 shows the backpressure measured for the fresh catalysts of Ref. Example 4′, Examples 11.1, 11.2 and 11.3 (a) and for the aged catalysts (b) of Examples 11.1, 11.2 and 11.3.

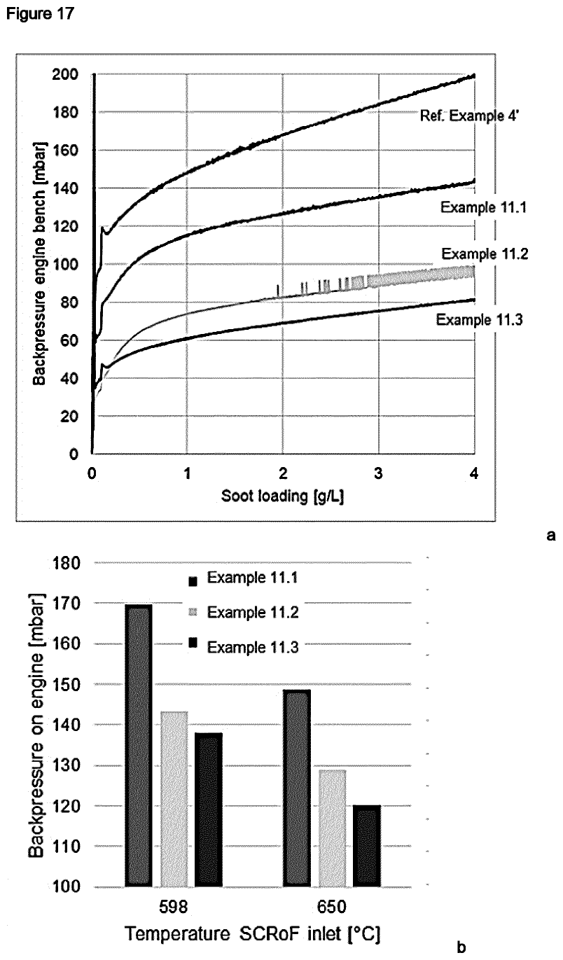

### CITED LITERATURE

WO2020/040944A1
GB2528737B
WO 2020/088531 A

1. A catalyst for the selective catalytic reduction of NOx comprising
a wall-flow filter substrate comprising an inlet end, an outlet end, a substrate axial length extending from the inlet end to the outlet end and a plurality of passages defined by inter-nal walls of the substrate extending therethrough, wherein the plurality of passages com-prises inlet passages having an open inlet end and a closed outlet end, and outlet pas-sages having a closed inlet end and an open outlet end;
wherein the porous walls of the substrate comprises a coating, the coating comprising a zeolitic material, copper, a first non-zeolitic oxidic material comprising zirconium, wherein the coating comprises the zeolitic material at loading, L(z), in g/in³, and the first non-zeolitic oxidic material at a loading L1, in g/in³, the loading ratio L(z) (g/in³):L1 (g/in³) being of at most 10:1; and
wherein from 90 to 100 weight-% of the first non-zeolitic oxidic material consists of zirconium, calculated as ZrO2.

2. The catalyst of claim 1, wherein from 95 to 100 weight-%, preferably from 98 to 100 weight-%, more preferably from 99 to 100 weight-% of the framework structure of the zeo-litic material comprised in the coating consist of Si, Al, and 0, wherein in the framework structure, the molar ratio of Si to Al, calculated as molar SiO2:Al2O3, is preferably in the range of from 2:1 to 30:1, more preferably in the range of from 5:1 to 25:1, more preferably in the range of from 7:1 to 22:1, more preferably in the range of from 8:1 to 20:1, more preferably in the range of from 9:1 to 18:1, more preferably in the range of from 10:1 to 17:1, more preferably in the range of from 12:1 to 16:1.

3. The catalyst of claim 1, wherein the amount of copper comprised in the coating, calculated as CuO, is in the range of from 2 to 10 weight-%, preferably in the range of from 2.5 to 5.5 weight-%, more preferably in the range of from 3 to 5 weight-% based on the weight of the zeolitic material.

4. The catalyst of claim 1, wherein from 95 to 100 weight-%, preferably from 98 to 100 weight-%, more preferably from 99 to 100 weight-%, more preferably from 99.5 to 100 weight-%, of the first non-zeolitic oxidic material comprised in the coating consists of zirconium, calculated as ZrO2.

5. The catalyst of claim 1, wherein the coating comprises the zeolitic material at loading, L(z), in g/in³, and the first non-zeolitic oxidic material, preferably zirconia, at a loading L1, in g/in³, wherein the loading ratio L(z) (g/in³):L1 (g/in³) is in the range of from 10:1 to 1.1:1, preferably in the range of from 9:1 to 1.25:1, more preferably in the range of from 8:1 to 2:1, more preferably in the range of from 7.5:1 to 2.5:1, more preferably in the range of from 7:1 to 3.5:1, more preferably in the range of from 5.5:1 to 4:1.

6. The catalyst of claim 1, wherein the coating further comprises a second non-zeolitic oxidic material selected from the group consisting of alumina, silica, titania, ceria, a mixed oxide comprising one or more of Al, Si, Ti, and Ce and a mixture of two or more thereof, preferably selected from the group consisting of alumina, silica, and titania, a mixed oxide comprising one or more of Al, Si, and Ti and a mixture of two or more thereof, more preferably selected from the group consisting of alumina, silica, a mixed oxide comprising one or more of Al and Si, and a mixture of two or more thereof, more preferably is a mixture of alumina and silica;
wherein preferably from 80 to 99 weight-%, more preferably from 85 to 98 weight-%, more preferably from 90 to 98 weight-%, of the mixture of alumina and silica consist of alumina, and from 1 to 20 weight-%, preferably from 2 to 15 weight-%, more preferably from 2 to 10 weight-% of the mixture of alumina and silica consist of silica.

7. The catalyst of claim 6, wherein the coating comprises the second non-zeolitic oxidic material in an amount in the range of from 2 to 20 weight-%, preferably in the range of from 5 to 15 weight-%, more preferably in the range of from 7 to 13 weight-%, based on the weight of the zeolitic material.

8. The catalyst of claim 1, wherein from 90 to 100 weight-%, preferably from 95 to 100 weight-%, more preferably from 98 to 100 weight-%, of the coating is comprised in the porous walls of the substrate.

9. The catalyst of claim 1, wherein the substrate is one or more of a cordierite wall-flow filter substrate, a silicon carbide wall-flow filter substrate and an aluminum titanate wall-flow filter substrate, preferably one or more of a silicon carbide wall-flow filter substrate and an aluminum titanate wall-flow filter substrate.

10. A process for preparing a catalyst for the selective catalytic reduction of NOx, preferably the catalyst according to claim 1, the process comprising
(i′) preparing a first aqueous mixture comprising water, a source of copper and a pre-cursor of a first non-zeolitic oxidic component comprising zirconium;
(ii′) admixing a zeolitic material, wherein the zeolitic material is free of copper, with the first mixture obtained according to (i′), obtaining a second aqueous mixture, wherein in the second aqueous mixture, the amount of the precursor of the first non-zeolitic oxidic component, calculated as an oxide, is of at least 10 weight-% based on the weight of the zeolitic material;
(iii′) disposing the second aqueous mixture on a wall-flow filter substrate comprising an inlet end, an outlet end, a substrate axial length extending from the inlet end to the outlet end and a plurality of passages defined by internal walls of the substrate extending therethrough, wherein the plurality of passages comprises inlet passages having an open inlet end and a closed outlet end, and outlet passages having a closed inlet end and an open outlet end; and optionally drying the substrate comprising said mixture;
(iv′) calcining the substrate obtained in (iii′).

11. The process of claim 10, wherein the precursor of a first non-zeolitic oxidic component comprised in the first aqueous mixture prepared in (i′) is a zirconium salt or a zirconium oxide, preferably a zirconium salt, more preferably zirconium acetate.

12. The process of claim 10, wherein (i′) comprises
(i′.1) preparing a mixture comprising water and the source of copper, the mixture preferably further comprising an acid, more preferably an organic acid, more preferably acetic acid, wherein more preferably the mixture comprises sucrose, wherein more preferably the weight ratio of copper, calculated as CuO, relative to sucrose is in the range of from 2:1 to 1:2, more preferably in the range of from 1.5:1 to 1:1.5, more preferably in the range of from 1.2:1 to 1:1.2;
(i′.2) adding the precursor of the first non-zeolitic oxidic component to the mixture obtained according to (i′.1), obtaining the first aqueous mixture.

13. The process of claim 12, wherein from 90 to 100 weight-%, preferably from 93 to 99 weight-%, more preferably from 96 to 99 weight-%, of the source of copper is present in the mixture prepared in (i′.1) in non-dissolved state; wherein the particles of copper in the mixture according to (i′.1) have a Dv90 in the range of from 0.1 to 15 micrometers, prefer-ably in the range of from 0.5 to 10 micrometers, more preferably in the range of from 1 to 8 micrometers, more preferably in the range of from 3 to 7 micrometers.

14. The process of claim 10, wherein (ii′) comprises
(i′) admixing a zeolitic material, wherein the zeolitic material is preferably free of Cu, with the first aqueous mixture obtained according to (i′);
(ii′) preferably milling the obtained mixture (ii′.1), more preferably until the particles of said mixture have a Dv90 in the range of from 0.5 to 8 micrometers, more prefer-ably in the range of from 1 to micrometers, more preferably in the range of from 1.5 to 4 micrometers;
(iii′) admixing the second mixture obtained in (ii′.1), preferably in (ii′.2), with a second non-zeolitic oxidic material selected from the group consisting of alumina, silica, titania, ceria, a mixed oxide comprising one or more of Al, Si, Ti, and Ce and a mixture of two or more thereof, obtaining the second aqueous mixture.

15. The process of claim 10, wherein disposing according to (iii′) comprises
(iii′.1) disposing a first portion of the second aqueous mixture obtained in (ii′) on a wall-flow filter substrate comprising an inlet end, an outlet end, a substrate axial length ex-tending from the inlet end to the outlet end and a plurality of passages defined by internal walls of the substrate extending therethrough, wherein the plurality of pas-sages comprises inlet passages having an open inlet end and a closed outlet end, and outlet passages having a closed inlet end and an open outlet end; and drying the substrate comprising the first portion of the second aqueous mixture;
(iii′.2) disposing a second portion of the second aqueous mixture obtained in (ii′) on the substrate comprising the first portion of the third aqueous mixture obtained in (iii′.1), and optionally drying the substrate comprising the first portion and the second portion of the second aqueous mixture.

16. An exhaust gas treatment system for treating exhaust gas exiting a compression ignition engine, said exhaust gas treatment system having an upstream end for introducing said exhaust gas stream into said exhaust gas treatment system, wherein said exhaust gas treatment system comprises a catalyst according to claim 1, one or more of a diesel oxidation catalyst, a selective catalytic reduction catalyst, an ammonia oxidation catalyst, a NOx trap and a particulate filter;
wherein the system preferably comprises the catalyst, a diesel oxidation catalyst and a selective catalytic reduction catalyst;
wherein the diesel oxidation catalyst more preferably is located upstream of the selective catalytic reduction catalyst and the selective catalytic reduction catalyst is located up-stream of the catalyst; or
wherein the diesel oxidation catalyst more preferably is located upstream of the catalyst and the catalyst is located upstream of the selective catalytic reduction catalyst.

17. Use of a catalyst according to claim 1 for the selective catalytic reduction of NOx.
